(19) United States
(12) Patent Application Publication
(10) Pub. No.: US 2024/0290008 A1
(43) Pub. Date: Aug. 29, 2024

(54) METHOD AND APPARATUS FOR IMAGE PROCESSING

(71) Applicants: Trustees of Tufts College, Medford, MA (US); Research Foundation of the City University of New York, New York, NY (US)

(72) Inventors: Karen A. Panetta, Rockport, MA (US); Sos S. Agaian, New York, NY (US); Thaweesak Trongtirakul, Samut Sakhon (TH)

(73) Assignees: Trustees of Tufts College, Medford, MA (US); Research Foundation of the City University of New York, New York, NY (US)

(21) Appl. No.: 18/568,992

(22) PCT Filed: Jun. 13, 2022
(86) PCT No.: PCT/US2022/033276

§ 371 Date: Dec. 11, 2023

Related U.S. Application Data
(60) Provisional application No. 63/202,469, filed on Jun. 11, 2021.

(51) Int. Cl. G06T 11/00; G06T 5/40; G06T 5/50; G06T 5/60; G06V 10/56; G06V 10/764; G06V 10/82

(52) U.S. Cl. CPC G06T 11/001; G06T 5/40; G06T 5/50; G06T 5/60; G06V 10/56; G06V 10/764; G06V 10/82; G06T 2207/10024; G06T 2207/20072; G06T 2207/20084; G06T 2207/20221

(57) ABSTRACT

A method comprising: receiving a hyperspectral image of a scene; selecting one or more bands from the hyperspectral image; and processing the selected bands to produce a color image, wherein processing the selected bands to produce a color image includes: generating an LMS image by performing an RGB-to-LMS conversion on the selected bands; replacing a V-channel of an HSV image with an enhanced L-channel of the LMS image to produce a resultant HSV image, the HSV image being an image of the same scene as the hyperspectral image; and performing an HSV-to-RGB conversion on the resultant HSV image produces the color image.

### CROSS-REFERENCE TO RELATED APPLICATIONS

The present application claims the benefit of U.S. Provisional Patent Application No. 63/202,469 filed on Jun. 11, 2021, and entitled HUMAN VISUAL SYSTEM BASED-HYPERSPECTRAL CUBE BAND SELECTION, RECOLORING, AND DISPLAYING METHODS AND SYSTEMS, which is incorporated herein by reference in its entirety.

### BACKGROUND

Hyperspectral imaging (HSI) is a technique used in various applications, such as pharmaceutical applications, forensic applications, medical applications, remote sensing applications, biotechnology applications, and applications relating to oil and gas exploration and environmental monitoring. Hyperspectral imaging often involves the (concurrent or simultaneous) imaging of a scene in 200 or more bands. By way of example, each of the bands may be a portion of one of: the ultraviolet range (200-400 nm.), the visible range (400-700 nm.), the near-infrared range (700-1000 nm.), and the short-wave infrared range (1,000-4,000 nm.).

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided comprising: receiving a hyperspectral image of a scene; selecting one or more bands from the hyperspectral image; and processing the selected bands to produce a color image.

In an embodiment, processing the selected bands to produce a color image includes: generating an LMS image by performing an RGB-to-LMS conversion on the selected bands; replacing a V-channel of an HSV image with an enhanced L-channel of the LMS image to produce a resultant HSV image, the HSV image being an image of the same scene as the hyperspectral image; and performing an HSV-to-RGB conversion on the resultant HSV image to produce the color image.

In an embodiment, replacing the V-channel of the HSV image with the L-channel of the LMS image includes replacing the L-channel with a logarithmic of the L-channel.

In an embodiment, processing the selected bands to produce a color image includes coloring the selected bands by using a fusion color map to produce the color image, the fusion color map being arranged to fuse a plurality of different color models.

In an embodiment, the plurality of different color models includes a jet color model, a rainbow color model, and a sine color model.

In an embodiment, processing the selected bands to produce a color image includes: generating a grayscale image by performing RGB-to-grayscale conversion on the selected bands; and coloring the grayscale image by using a fusion color map to produce the color image, the fusion color map being arranged to fuse a plurality of different color models.

In an embodiment, the fusion color map is defined by the equations of:

$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$

$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$

$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$

where β₁ and β₂ represent weights of a color map, Lₘᵢₙ and Lₘₐₓ represent minimum and maximum color luminance levels, respectively, x represents a grayscale luminance level, L represent a total number of luminance levels of the grayscale image, c, αᵣ, α_{g} and α_{b} represent a color constant, and xᵢ represents a grayscale luminance threshold, x_{i=1,2, . . . , 7}=(iL/8)−1, R_{J}(x) is a function defining a red channel of a first color model, G_{J}(x) is a function defining a green channel of a first color model, B_{J}(x) is a function defining a blue channel of a first color model, R_{P}(x) is a function defining a red channel of a second color model, G_{P}(x) is a function defining a green channel of a second color model, B_{P}(x) is a function defining a blue channel of a second color model, R_{R}(x) is a function defining a red channel of a third color model, G_{R}(x) is a function defining a green channel of a third color model, B_{R}(x) is a function defining a blue channel of a third color model.

In an embodiment, processing the selected bands to produce a color image includes: generating an LMS image by performing an RGB-to-LMS conversion on the selected bands; extracting a channel of the LMS image; and coloring the extracted channel with a color map to produce the color image.

In an embodiment, classifying the color image with a neural network, the neural network including at least one hidden layer that implements a discrete Chebyshev transform, the discrete Chebyshev transform including at least one of a one-dimensional Chebyshev transform a two-dimensional Chebyshev transform, and a three-dimensional Chebyshev transform, wherein the neural network further includes one or more layers that are arranged to form a feedforward sub-network, the feedforward sub-network being arranged to classify a set of features that is produced, at least in part, by the at least one hidden layer, the set of features being produced based on the color image.

According to aspects of the disclosure, a method is provided comprising: receiving a hyperspectral image; calculating an unsupervised HVS-based selection measure (BBS) that is defined by the equations of:

$$BBS = \frac{0.5681}{N \cdot M} {\sum }_{i = 1}^{N} {\sum }_{j = 1}^{M} Δ D \cdot log ( \frac{Δ D + c}{{[ {I}_{max} ]}_{i , j}^{m , n} + {[ {I}_{min} ]}_{i , j}^{m , n} + c} ) Δ D = {[ {I}_{max} ]}_{i , j}^{m , n} - {[ {I}_{min} ]}_{i , j}^{m , n} ;$$

ΔD>τ where N and M represent a size of the hyperspectral image in width and height, m and n denote a size of a local block, [Iₘᵢₙ]_{i,j}^{m,n} and [Iₘₐₓ]_{i,j}^{m,n} are a block-based minimum luminance and a block-based maximum luminance, respectively, c is a constant, and r is a threshold value; generating a band measure histogram; smoothening the histogram; selecting a most informative band on the smoothened histogram; selecting a plurality of bands around the most informative band; and combining the selected bands to produce a single-channel image.

According to aspects of the disclosure, a method is provided comprising receiving a hyperspectral image; calculating an unsupervised HVS-based selection measure (BBS) that is defined by the equations of:

$${BBS}_{λ} = \frac{0.5681}{N \cdot M} {\sum }_{i = 1}^{N} {BBS}_{i , j , λ} , \text{} {BBS}_{i , j , λ} = {\sum }_{j = 1}^{M} Δ D \cdot log ( \frac{Δ D + c}{{[ {I}_{max} ]}_{i , j , λ}^{m , n} + {[ {I}_{min} ]}_{i , j , λ}^{m , n} + c} ) , Δ D = {[ {I}_{max} ]}_{i , j , λ}^{m , n} - {[ {I}_{min} ]}_{i , j , λ}^{m , n} ,$$

ΔD>τ where N and M represent a size of the hyperspectral image in width and height, m and n denote a size of a local block, [Iₘᵢₙ]_{i,j,λ}^{m,n} and [Iₘₐₓ]_{i,j,λ}^{m,n} are a block-based minimum luminance and a block-based maximum luminance, respectively, c is a constant, and i is a threshold value; generating a band measure histogram; smoothening the histogram; selecting, based on the smoothened histogram, a plurality of bands that correspond to local maxima; selecting, based on the smoothened histogram, a plurality of additional bands; and combining the bands that correspond to local maxima and the plurality of additional bands to produce a multiple-band image.

According to aspects of the disclosure, a method is provided comprising: receiving a single-channel image; and coloring the single-channel image with a fusion color map to produce a color image, the fusion color map being arranged to fuse a plurality of different color models.

In an embodiment, wherein the fusion color map is defined by the equations of:

$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$

$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$

$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$

where β₁ and β₂ represent weights of a color map, Lₘᵢₙ and Lₘₐₓ represent minimum and maximum color luminance levels, respectively, x represents a grayscale luminance level, L represent a total number of luminance levels of the single-channel image, c, αᵣ, α₉ and α_{b} represent a color constant, and xᵢ represents a grayscale luminance threshold, x_{i=1,2, . . . , 7}(iL/8)−1, R_{J}(x) is a function defining a red channel of a first color model, G_{J}(x) is a function defining a green channel of a first color model, B_{J}(x) is a function defining a blue channel of a first color model, R_{P}(x) is a function defining a red channel of a second color model, G_{P}(x) is a function defining a green channel of a second color model, B_{P}(x) is a function defining a blue channel of a second color model, R_{R}(x) is a function defining a red channel of a third color model, G_{R}(x) is a function defining a green channel of a third color model, B_{R}(x) is a function defining a blue channel of a third color model.

In an embodiment, the single-channel image includes a grayscale image.

In an embodiment, the single-channel image includes one of the channels in a multi-channel image.

In an embodiment, the single-channel image is generated by extracting one or more channels from a hyperspectral image.

In an embodiment, calculating image dependent-thresholds (x₁, x₂, . . . , xₙ) based on a total count of luminance levels in the single-channel image, wherein the fusion map is based on the image dependent thresholds.

According to aspects of the disclosure, a method is provided comprising: receiving a hyperspectral image; and classifying the image with at least one neural network that includes at least one hidden layer that is configured to implement a discrete Chebyshev transform.

In an embodiment, the discrete Chebyshev transform includes at least one of a one-dimensional Chebyshev transform, a two-dimensional Chebyshev transform, and a three-dimensional Chebyshev transform.

In an embodiment, the neural network further includes one or more bands/layers that are arranged to form a feedforward sub-network, the feedforward sub-network being arranged to classify a set of features that is produced, at least in part, by the at least one hidden layer, the set of features being produced based on the image.

In an embodiment, classifying the image with at least one neural network includes: generating a one-dimensional signal based on the hyperspectral image and generating a first set of features based on the one-dimensional signal, the first set of features being generated by using a one-dimensional discrete Chebyshev transform; generating a two-dimensional image based on the hyperspectral image and generating a second set of features based on the two-dimensional image, the second set of features being generated by using a two-dimensional or three-dimensional discrete Chebyshev transform; generating a combined set of features based on the first set of features and the second set of features; and classifying the combined set of features.

According to aspects of the disclosure, a system is provided, comprising: a memory; and at least one processor operatively coupled to the memory, the at least one processor being configured to perform the operations of: receiving a hyperspectral image of a scene; selecting one or more bands from the hyperspectral image; and processing the selected bands to produce a color image.

In an embodiment, processing the selected bands to produce a color image includes: generating an LMS image by performing an RGB-to-LMS conversion on the selected bands; replacing a V-channel of an HSV image with an enhanced L-channel of the LMS image to produce a resultant HSV image, the HSV image being an image of the same scene as the hyperspectral image; and performing an HSV-to-RGB conversion on the resultant HSV image to produce the color image.

In an embodiment, replacing the V-channel of the HSV image with the L-channel of the LMS image includes replacing the L-channel with a logarithmic of the L-channel.

In an embodiment, processing the selected bands to produce a color image includes coloring the selected bands by using a fusion color map to produce the color image, the fusion color map being arranged to fuse a plurality of different color models.

In an embodiment, the plurality of different color models includes a jet color model, a rainbow color model, and a sine color model.

In an embodiment, processing the selected bands to produce a color image includes: generating a grayscale image by performing RGB-to-grayscale conversion on the selected bands; and coloring the grayscale image by using a fusion color map to produce the color image, the fusion color map being arranged to fuse a plurality of different color models.

In an embodiment, the fusion color map is defined by the equations of:

$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$

$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$

$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$

where β₁ and β₂ represent weights of a color map, Lₘᵢₙ and Lₘₐₓ represent minimum and maximum color luminance levels, respectively, x represents a grayscale luminance level, L represent a total number of luminance levels of the grayscale image, c, αᵣ, α₉ and α_{b} represent a color constant, and xᵢ represents a grayscale luminance threshold, x_{i=1,2, . . . , 7}(iL/8)−1, R_{J}(x) is a function defining a red channel of a first color model, G_{J}(x) is a function defining a green channel of a first color model, B_{J}(x) is a function defining a blue channel of a first color model, R_{P}(x) is a function defining a red channel of a second color model, G_{P}(x) is a function defining a green channel of a second color model, B_{P}(x) is a function defining a blue channel of a second color model, R_{R}(x) is a function defining a red channel of a third color model, G_{R}(x) is a function defining a green channel of a third color model, B_{R}(x) is a function defining a blue channel of a third color model.

In an embodiment, processing the selected bands to produce a color image includes: generating an LMS image by performing an RGB-to-LMS conversion on the selected bands; extracting a channel of the LMS image; and coloring the extracted channel with a color map to produce the color image.

In an embodiment, the at least one processor is further configured to perform the operation of classifying the color image with a neural network, the neural network including at least one hidden layer that implements a discrete Chebyshev transform, the discrete Chebyshev transform including at least one of a one-dimensional Chebyshev transform a two-dimensional Chebyshev transform, and a three-dimensional Chebyshev transform, and the neural network further includes one or more layers that are arranged to form a feedforward sub-network, the feedforward sub-network being arranged to classify a set of features that is produced, at least in part, by the at least one hidden layer, the set of features being produced based on the color image.

According to aspects of the disclosure, a system is provided, comprising: a memory; and at least one processor that is operatively coupled to the memory, the at least one processor being configured to perform the operations of: receiving a hyperspectral image; calculating an unsupervised HVS-based selection measure (BBS) that is defined by the equations of:

$$BBS = \frac{0.5681}{N \cdot M} {\sum }_{i = 1}^{N} {\sum }_{j = 1}^{M} \text{} Δ \text{ } D \cdot log ( \frac{Δ D + c}{{[ {I}_{max} ]}_{i , j}^{m , n} + {[ {I}_{min} ]}_{i , j}^{m , n} + c} ) , \text{} Δ D = {[ {I}_{max} ]}_{i , j}^{m , n} - {[ {I}_{min} ]}_{i , j}^{m , n} ;$$

where N and M represent a size of the hyperspectral image in width and height, m and n denote a size of a local block, [Iₘᵢₙ]_{i,j}^{m,n} and [Iₘₐₓ]_{i,j}^{m,n} are a block-based minimum luminance and a block-based maximum luminance, respectively, c is a constant, and r is a threshold value; generating a band measure histogram; smoothening the histogram; selecting a most informative band on the smoothened histogram; selecting a plurality of bands around the most informative band; and combining the selected bands to produce a single-channel image.

According to aspects of the disclosure, a system is provided, comprising: a memory; and at least one processor that is operatively coupled to the memory, the at least one processor being configured to perform the operations of: receiving a hyperspectral image; calculating an unsupervised HVS-based selection measure (BBS) that is defined by the equations of:

$${BBS}_{λ} = \frac{0.5681}{N \cdot M} {\sum }_{i = 1}^{N} {BBS}_{i , j , λ} , {BBS}_{i , j , λ} = {\sum }_{j = 1}^{M} Δ D \cdot log ( \frac{Δ D + c}{{[ {I}_{max} ]}_{i , j , λ}^{m , n} + {[ {I}_{min} ]}_{i , j , λ}^{m , n} + c} ) , Δ D = {[ {I}_{max} ]}_{i , j , λ}^{m , n} - {[ {I}_{min} ]}_{i , j , λ}^{m , n} ;$$

ΔD>τ, where N and M represent a size of the hyperspectral image in width and height, m and n denote a size of a local block, [Iₘᵢₙ]_{i,j,λ}^{m,n} and [Iₘₐₓ]_{i,j,λ}^{m,n} are a block-based minimum luminance and a block-based maximum luminance, respectively, c is a constant, and τ is a threshold value; generating a band measure histogram; smoothening the histogram; selecting, based on the smoothened histogram, a plurality of bands that correspond to local maxima; selecting, based on the smoothened histogram, a plurality of additional bands; and combining the bands that correspond to local maxima and the plurality of additional bands to produce a multiple-band image.

According to aspects of the disclosure, a system is provided comprising: a memory; and at least one processor operatively coupled to the memory, the at least one processor being configured to perform the operations of: receiving a single-channel image; and coloring the single-channel image with a fusion color map to produce a color image, the fusion color map being arranged to fuse a plurality of different color models.

In an embodiment, the fusion color map being defined by the equations of:

$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$

$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$

$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$

where β₁ and β₂ represent weights of a color map, Lₘᵢₙ and Lₘₐₓ represent minimum and maximum color luminance levels, respectively, x represents a grayscale luminance level, L represent a total number of luminance levels of the single-channel image, c, αᵣ, α_{g} and α_{b} represent a color constant, and xᵢ represents a grayscale luminance threshold, x_{i=1,2, . . . , 7}=(iL/8)−1, R_{J}(x) is a function defining a red channel of a first color model, G_{J}(x) is a function defining a green channel of a first color model, B_{J}(x) is a function defining a blue channel of a first color model, Rₚ(x) is a function defining a red channel of a second color model, Gₚ(x) is a function defining a green channel of a second color model, Bₚ(x) is a function defining a blue channel of a second color model, R_{R}(x) is a function defining a red channel of a third color model, G_{R}(x) is a function defining a green channel of a third color model, B_{R}(x) is a function defining a blue channel of a third color model.

In an embodiment, the single-channel image includes a grayscale image.

In an embodiment, the single-channel image includes one of the channels in a multi-channel image.

In an embodiment, the single-channel image is generated by extracting one or more channels from a hyperspectral image.

In an embodiment, calculating image dependent-thresholds (x₁, x₂, . . . , xₙ) based on a total count of luminance levels in the single-channel image, wherein the fusion map is based on the image dependent thresholds.

According to aspects of the disclosure, a system is provided comprising: a memory; and at least one processor that is operatively coupled to the memory, the at least one processor being configured to perform the operations of: receiving a hyperspectral image; and classifying the image with at least one neural network that includes at least one hidden layer that is configured to implement a discrete Chebyshev transform.

In an embodiment, the discrete Chebyshev transform includes at least one of a one-dimensional Chebyshev transform, a two-dimensional Chebyshev transform, and a three-dimensional Chebyshev transform.

In an embodiment, the neural network further includes one or more bands/layers that are arranged to form a feedforward sub-network, the feedforward sub-network being arranged to classify a set of features that is produced, at least in part, by the at least one hidden layer, the set of features being produced based on the image.

In an embodiment, classifying the image with at least one neural network includes: generating a one-dimensional signal based on the hyperspectral image and generating a first set of features based on the one-dimensional signal, the first set of features being generated by using a one-dimensional discrete Chebyshev transform; generating a two-dimensional image based on the hyperspectral image and generating a second set of features based on the two-dimensional image, the second set of features being generated by using a two-dimensional or three-dimensional discrete Chebyshev transform; generating a combined set of features based on the first set of features and the second set of features; and classifying the combined set of features.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a flowchart of an example of a process, according to aspects of the disclosure;

FIG. 1B is a flowchart of an example of a process, according to aspects of the disclosure;

FIG. 1C is a flowchart of an example of a process, according to aspects of the disclosure;

FIG. 2 is a flowchart of an example of a process, according to aspects of the disclosure;

FIG. 3 is a plot of a histogram, according to aspects of the disclosure;

FIG. 4 is a flowchart of an example of a process, according to aspects of the disclosure;

FIG. 5 is a plot of a histogram, according to aspects of the disclosure;

FIG. 6A is a flowchart of an example of a process, according to aspects of the disclosure;

FIG. 6B is a flowchart of an example of a process, according to aspects of the disclosure;

FIG. 7 is a flowchart of an example of a process, according to aspects of the disclosure;

FIG. 8 is a plot of the LMS color space, according to aspects of the disclosure.

FIG. 9 is a diagram of an example of a process, according to aspects of the disclosure;

FIG. 10 shows examples of different color maps, according to aspects of the disclosure;

FIG. 11 shows an example of a color map, according to aspects of the disclosure;

FIG. 12 shows an example of a color map, according to aspects of the disclosure;

FIG. 13 shows an example of a color map, according to aspects of the disclosure;

FIG. 14 is a flowchart of an example of a process, according to aspects of the disclosure;

FIG. 15 is a diagram of an example of a process, according to aspects of the disclosure;

FIG. 16 is a flowchart of an example of a process, according to aspects of the disclosure;

FIG. 17 shows an example of different images, according to aspects of the disclosure;

FIG. 18 shows an example of different images, according to aspects of the disclosure;

FIG. 19A is a plot of an example of a polynomial, according to aspects of the disclosure;

FIG. 19B shows an example of an image dataset, according to aspects of the disclosure;

FIG. 20A is a diagram of an example of a process, according to aspects of the disclosure;

FIG. 20B is a diagram of an example of a neural network, according to aspects of the disclosure;

FIG. 21 is a diagram of an example of a computing device, according to aspects of the disclosure; and

FIG. 22 is a flowchart of an example of a process, according to aspects of the disclosure.

### DETAILED DESCRIPTION

### Part A

A.1. Introduction. The set of bands that constitute an HSI image is referred to as an imaging cube. Each of the bands may be represented by a respective array of pixels that are captured in the band's respective wavelength range. Band selection (BS) is one of the most exciting and challenging aspects of HSI reduction and representation in recent years. Typically, the highly-correlated spectral bands bring information redundancy and complex computation in HSI data analysis. The HSI band selection (BS) problem can be mathematically formulated as: a mapping of a given an N×h HSI cube with N bands into a lower-dimensionality, k, k<N bands containing maximum HSI information. The number k of chosen bands is user-defined. This paper considers k=1 and k=3, which corresponds to a trichromatic displaying range of a monitor. The goal of HSI visualization is to provide i) information as much as possible from original data and facilitate easy image analysis, interpretation, and classification; and ii) the ability to utilize the color image processing tools.

The present disclosure generally relates to systems and methods for hyperspectral image analytics, particularly for (i) visualizing hyperspectral images using band selection, (ii) optimal image quality enhancement, re-coloring (or color mapping), (iii) unsupervised hyperspectral image (HSI) special dimensionality reduction and visualization problems, and (iv) visualizing on a trichromatic (color) display. According to aspects of the disclosure, a system is provided that is configured to provide automatic HSV-based trichromatic display HSI visualization to visualize an HSI cube or a trichromatic display using a human visual system method. The system implements computationally-efficient methods for band selection and color mapping. In operation, the system may map an HSI cube into a trichromatic display, while modifying one or more of: (1) the colorful appearance of the image (e.g., by using the so-called VisMap method), (2) the arrangement of the natural and physical features of topography (e.g., by using the so-called TopoMap method, (3) the natural appearance of the image (e.g., by using the so-called Rainbow Map method. In addition, the system may generate image-dependent colormaps in accordance with the VisMap method (which are subsequently used for color mapping the image), and enhance human visualization using image-dependent background removals.

In some implementations, the system may be configured to map an HSI cube into a trichromatic displaying range of a monitor without requiring training samples. The system may be configured to handle different imaging conditions, such as low-contrast, i.e., flat, ultra-dark, or ultra-bright cases. In addition, the system may provide to provide a good color visualization map (i.e., a colormap) dedicated to the unreduced (raw) spectral data that makes up an HSI image, which in turn enables the system to preserve maximum hyperspectral details or to consent to minimal information loss including edge salience, consistent rendering, and natural palette properties.

In some implementations, to achieve optimal HSI band enhancement, the system may use an adaptive inertia weight for a Particle Swarm Optimization (PSO) algorithm to search for the optimal non-linear parameters in the proposed image enhancement mechanism. The adaptive weight enables the enhancement algorithm to efficiently search for suitable solutions under a reasonable constraint. The invented image enhancement mechanism improves the spatial quality under the optimization algorithm. According to the present disclosure, it has been determined that the effectiveness of the adaptive inertia weight particle swarm algorithm for optimized hyperspectral image enhancement shows that the method outperforms other existing state-of-the-art visualization methods in terms of colorfulness, color contrast, entropy information, and average gradient.

The terms “color mapping” as used herein “refers” to coloring the image based on a colormap. The term colormap, refers to a set of functions. In instances in which an image is mapped to the RGB color space, the set of functions may include a first function that maps a first band in an HSI cube to the red band, a second function that maps a second band in the HSI to the green band, and a third function that maps a third band in the HSI image to the blue band. The term HSI cube, refers to an image including a plurality of bands. Each band may be an array of pixel values that correspond to a particular frequency range. In other words, as used throughout the disclosure, the term “band” pertains to the data that is captured in a particular signal wavelength band or the signal wavelength band itself.

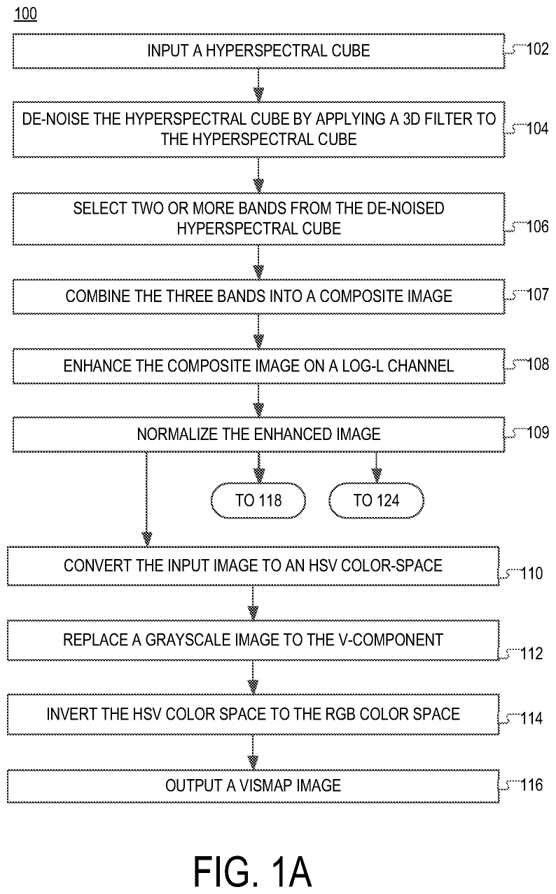

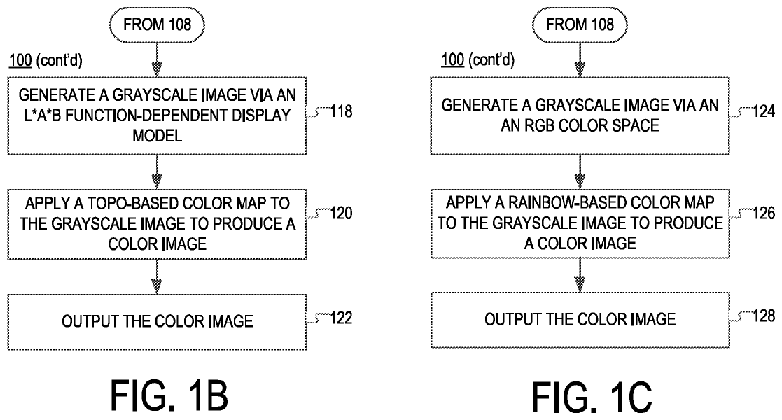

FIGS. 1A-C show a flowchart of an example of a process, 100 according to aspects of the disclosure. At step 102, an HSI cube is received as input. At step 104, the HSI cube is de-noised using a 3D filter. At step 106, two or more bands in the HSI cube are selected. At step 108, the selected bands are combined to produce a composite image. In the composite image, each of the selected bands may correspond to a different channel (e.g., red, green, or blue channel) of the image. At step 110, the composite image is converted to the HSV color space. The conversion may be performed as discussed in Smith, A. R. “Color Gamut Transform Pairs”. SIGGRAPH 78 Conference Proceedings. 1978, pp. 12-19. At step 112, the V component (or channel) of the HSV image is replaced with a grayscale image. The grayscale image may be based on one or more channels of the HSI image. The grayscale image may be an L*a*b* color space-based grayscale image. At step 116, the image that results after the execution of step 114 is inverted from the HSV color space to the RGB color space. The conversion may be performed by using any suitable technique for HSV-to-RGB mapping. In the conversion, the grayscale image (which is replaced into the V-channel of the HSV image) may be treated as a regular V-channel. At step 116, the resultant RGB image is output. At step 118, a grayscale image is generated. The grayscale image may be based on one or more channels of the HSI image. The grayscale image may be an L*a*b* color-space-based grayscale image. At step 120, a color image is generated by applying a rainbow-based colormap to the grayscale image. At step 122, the color image (generated at step 120) is output. At step 124, a grayscale image is generated via an RGB color space. The grayscale image may be generated by converting red, green, and blue channels of the HSI image into a grayscale image. At step 126, a color image is generated by applying a topo-based colormap to the grayscale image. At step 122, the color image (generated at step 126) is output.

In some implementations, the grayscale image (used in step 112) may be an (L*, a*, b*) color space image. The color space can be calculated from the tristimulus values XYZ that are obtained based on or more RGB-related bands in the HSI cube (received at step 102). The conversion to the (L*, a*, b*) in this color space can be performed in the manner discussed in J. Schwiegerling, Field Guide to Visual and Ophthalmic Optics, SPIE Press, Bellingham, WA (2004). In some implementations, the grayscale image may be calculated based on equations A0.1-A0.7, which are obtained from chrome-extension://efaidnbmnnnibpcajpcglclefindmkaj/https://www.uni-weimar.de/fileadmin/user/fak/medien/professuren/Computer_Graphics/3-ima-color-spaces17.pdf

$$[ \begin{matrix}{L}^{*} \\ {a}^{*} \\ {b}^{*}\end{matrix} ] = [ \begin{matrix}0 & 116 & 0 & - 16 \\ 500 & - 500 & 0 & 0 \\ 0 & 200 & - 200 & 0\end{matrix} ] [ \begin{matrix}f ( \frac{X}{{X}_{n}} ) \\ f ( \frac{Y}{{Y}_{n}} ) \\ f ( \frac{Z}{{Z}_{n}} ) \\ 1\end{matrix} ] \qquad ( A0 \text{.1} )$$

where the function f is defined as

$$f ( r ) = \{ \begin{matrix}\sqrt[3]{r} , & r > 0.008856 \\ 7.787 r + \frac{16}{116} , & r \leq 0.008856\end{matrix} \qquad ( A0 \text{.2} )$$

$$The inverse is$$

$$X = {X}_{n} \{ \begin{matrix}{( \frac{{L}^{*}}{116} + \frac{{a}^{*}}{500} + \frac{{b}^{*}}{116} )}^{3} , & {L}^{*} > 7.9996 \\ \frac{1}{7.787} ( \frac{{L}^{*}}{116} + \frac{{a}^{*}}{500} ) , & {L}^{*} \leq 7.9996\end{matrix} \qquad ( A0 \text{.3} )$$

$$Y = {Y}_{n} \{ \begin{matrix}{( \frac{{L}^{*}}{116} + \frac{16}{116} )}^{3} , & {L}^{*} > 7.9996 \\ \frac{1}{7.787} ( \frac{{L}^{*}}{116} ) , & {L}^{*} \leq 7.9996\end{matrix} \qquad ( A0 \text{.4} )$$

$$Z = {Z}_{n} \{ \begin{matrix}{( \frac{{L}^{*}}{116} - \frac{b}{200} + \frac{16}{116} )}^{3} , & {L}^{*} > 7.9996 \\ \frac{1}{7.787} ( \frac{{L}^{*}}{116} - \frac{{b}^{*}}{200} ) , & {L}^{*} \leq 7.9996\end{matrix} \qquad ( A0 \text{.5} )$$

(from chrome-extension://efaidnbmnnnibpcajpcglclefindmkaj/https://www.uni-weimar.de/fileadmin/user/fak/medien/professuren/Computer_Graphics/3-ima-color-spaces17.pdf)

The color conversion matrix between XYZ and RGB color space can be defined as follows:

$$[ \begin{matrix}X \\ Y \\ Z\end{matrix} ] = [ \begin{matrix}0.49 & 0.31 & 0.21 \\ 0.18 & 0.81 & 0.01 \\ 0. & 0.01 & 0.99\end{matrix} ] [ \begin{matrix}R \\ G \\ B\end{matrix} ] \qquad ( A0 \text{.6} )$$

$$[ \begin{matrix}R \\ G \\ B\end{matrix} ] = [ \begin{matrix}2.36 & - 0.89 & - 0.47 \\ - 0.52 & 1.42 & 0.09 \\ 0.01 & - 0.01 & 1.01\end{matrix} ] [ \begin{matrix}X \\ Y \\ Z\end{matrix} ] \qquad ( A0 \text{.7} )$$

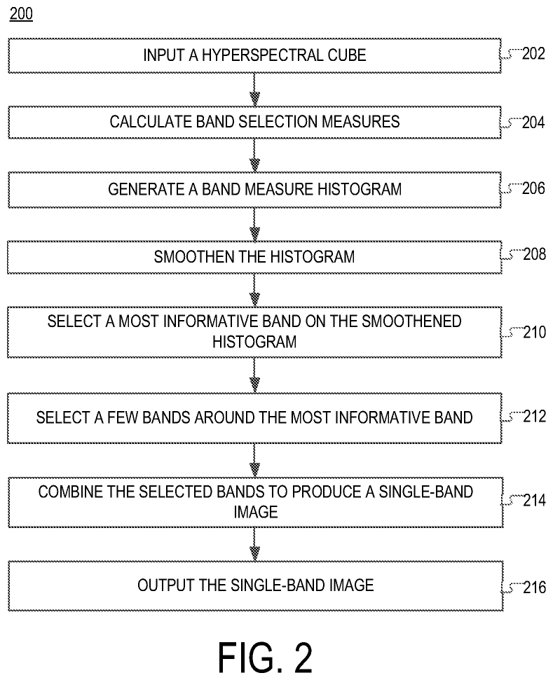

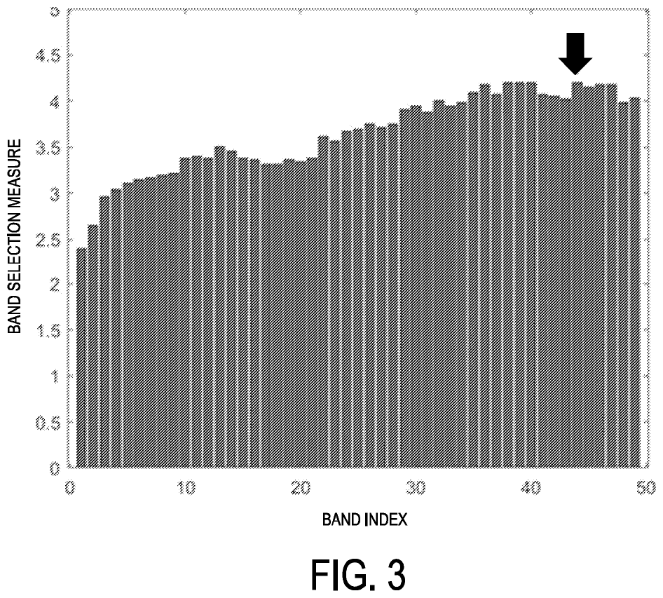

FIG. 2 is a flowchart of an example of a process 200, according to aspects of the disclosure. At step 202, an HSI cube is received as input. At step 204, a respective band selection measure is calculated for each band in the HSI cube. At step 206, a histogram is produced based on the band measures (generated at step 204). At step 208, the histogram is smoothened. At step 210, a maximum of the histogram is identified and the band corresponding to the maximum is selected. An example of the histogram is shown in FIG. 3, where the selected band is marked with a solid black arrow. At step 212, one or more bands that are adjacent to the selected band are also selected. For example, if the selected measure has index of 43, the additional bands may have indices 42 and 44, respectively. The indices of the bands may correspond to HSI wavelengths. At step 214, the bands selected at steps 210 and 212 are combined into a single band, to produce a single-band image. The bands may be combined by using weighting fusion and/or adaptive average combination. At step 216, the single-band image (generated at step 216) is output.

In some implementations, the selective band measure may be calculated, at step 204 in accordance with Equations A1 and A2 below:

$${C}_{i , k , λ} = \{ \begin{matrix}( {[ {I}_{max} ]}_{i , j , λ}^{m , n} - & {[ {I}_{max} ]}_{i , j , λ}^{m , n} - \\ {[ {I}_{min} ]}_{i , j , λ}^{m , n} {log}^{γ} ( \frac{{[ {I}_{max} ]}_{i , j , λ}^{m , n} - {[ {I}_{min} ]}_{i , j , λ}^{m , n} + c}{{[ {I}_{max} ]}_{i , j , λ}^{m , n} + {[ {I}_{min} ]}_{i , j , λ}^{m , n} + c} ) , & {[ {I}_{min} ]}_{i , j , λ}^{m , n} \geq {τ}_{HSV} \\ 0 , & {[ {I}_{max} ]}_{i , j , λ}^{m , n} - \\ & {[ {I}_{min} ]}_{i , j , λ}^{m , n} < {τ}_{HSV}\end{matrix} \qquad ( A1 )$$

$${MEME}_{λ} = \frac{1}{M \times N} {\sum }_{i = 1}^{M} {\sum }_{j = 1}^{N} {C}_{i , k , λ} \qquad ( A2 )$$

where [Iₘᵢₙ]_{i,j,λ}^{m,n} and [Iₘₐₓ]_{i,j,λ}^{m,n}, represent a local minimum metric and a local maximum metric, respectively. c represents a small number to avoid the calculation error. γ represents a power factor. τ_{HSV} represent a human visual system-based threshold. M and N represent the size of a hyperspectral cube in row and column, respectively. m and n represent the size of a local tile in row and column, respectively.

In some implementations, the selected bands may be combined, at step 214, to produce a single-band image in accordance with equation A3 below:

$${A}_{i , j} = \{ \begin{matrix}\frac{1}{2 k + 1} {\sum }_{λ = 1}^{2 k} ( {I}_{i , j , λ} \cdot {ω}_{λ \pm k} ) , & \sum λ \leq T \\ \frac{1}{2 k + 1} {\sum }_{k = 1}^{2 k + 1} {I}_{i , j , λ} + \vert {I}_{i , j , λ} - {I}_{i , j , λ \pm k} \vert , & \sum λ > T\end{matrix} \qquad ( A3 )$$

where k represents the band order around the selected band, I_{i,j,λ}. ω represents a weight. T is a constant, for example, T=100, 101, . . . , n.

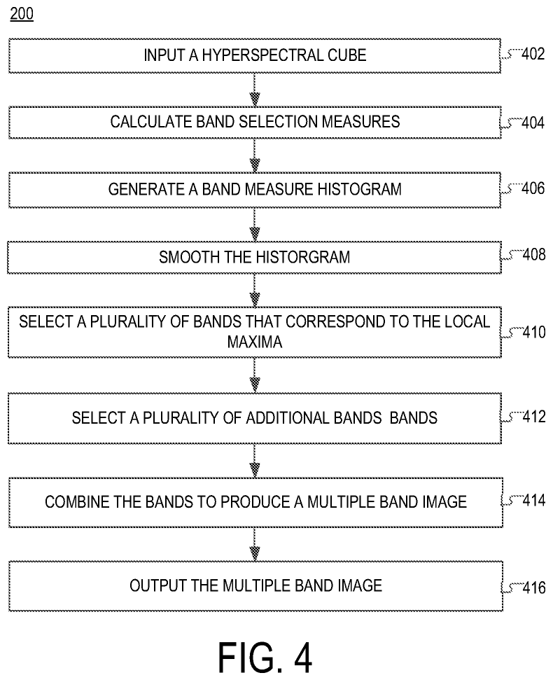

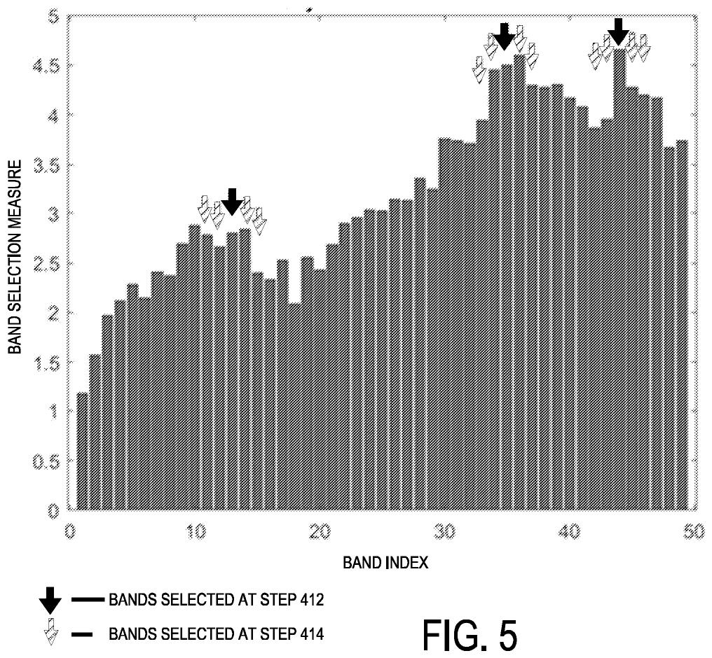

FIG. 4 is a flowchart of an example of a process 400, according to aspects of the disclosure. At step 402, an HSI cube is received as input. At step 404, a respective band selection measure is calculated for each band in the HSI cube. At step 406, a histogram is produced based on the band measures (generated at step 404). At step 408, the histogram is smoothened. At step 410, maxima in the histogram are identified and the bands corresponding to the maxima are selected. An example of the histogram is shown in FIG. 5, where the selected bands are marked with a solid black arrow. At step 412 one or more bands that are adjacent to the selected band are also selected. For example, if the selected bands have indices of 23, 43, the additional bands may have indices 22, 24, 42, and 44, respectively. At step 414, the bands selected at steps 410 and 412 are combined into multiple bands, to produce a multiple band image. The bands may be combined by using weighting fusion and/or adaptive average combination. At step 416, the multiple band image (generated at step 416) is output.

In some implementations, the band selection measures may be calculated, at step 404, based on equations A4 and A5 below:

$${C}_{i , k , λ} = \{ \begin{matrix}( {[ {I}_{max} ]}_{i , j , λ}^{m , n} - & {[ {I}_{max} ]}_{i , j , λ}^{m , n} - \\ {[ {I}_{min} ]}_{i , j , λ}^{m , n} {log}^{γ} ( \frac{{[ {I}_{max} ]}_{i , j , λ}^{m , n} - {[ {I}_{min} ]}_{i , j , λ}^{m , n} + c}{{[ {I}_{max} ]}_{i , j , λ}^{m , n} + {[ {I}_{min} ]}_{i , j , λ}^{m , n} + c} ) , & {[ {I}_{min} ]}_{i , j , λ}^{m , n} \geq {τ}_{HSV} \\ 0 , & {[ {I}_{max} ]}_{i , j , λ}^{m , n} - \\ & {[ {I}_{min} ]}_{i , j , λ}^{m , n} < {τ}_{HSV}\end{matrix} \qquad ( A4 )$$

$${MEME}_{λ} = \frac{1}{M \times N} {\sum }_{i = 1}^{M} {\sum }_{j = 1}^{N} {C}_{i , k , λ} \qquad ( A5 )$$

where [Iₘᵢₙ]_{i,j,λ}^{m,n} and [Iₘₐₓ]_{i,j,λ}^{m,n} represent a local minimum metric and a local maximum metric, respectively. c represents a small number to avoid the calculation error. γ represents a power factor. τ_{HSV} represent a human visual system-based threshold. M and N represent the size of a hyperspectral cube in row and column, respectively. m and n represent the size of a local tile in row and column, respectively.

In some implementations, the bands may be combined, at step 414, in accordance with equation A6 below:

$${A}_{i , j} = \{ \begin{matrix}\frac{1}{2 k + 1} {\sum }_{λ = 1}^{2 k} ( {I}_{i , j , λ} \cdot {ω}_{λ \pm k} ) , & \sum λ \leq T \\ \frac{1}{2 k + 1} {\sum }_{k = 1}^{2 k + 1} {I}_{i , j , λ} + \vert {I}_{i , j , λ} - {I}_{i , j , λ \pm k} \vert , & \sum λ > T\end{matrix} \qquad ( A6 )$$

where k represents the band order around the selected band, I_{i,j,λ}. ω represents a weight. T is a constant, for example, T=100, 101, . . . , n.

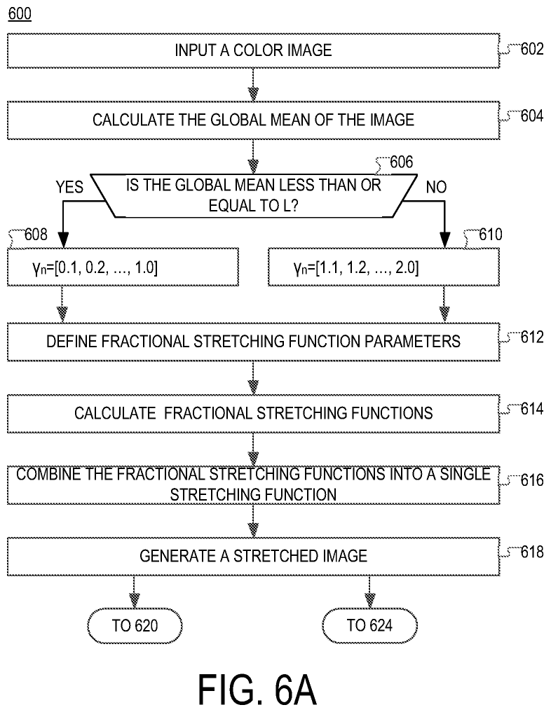

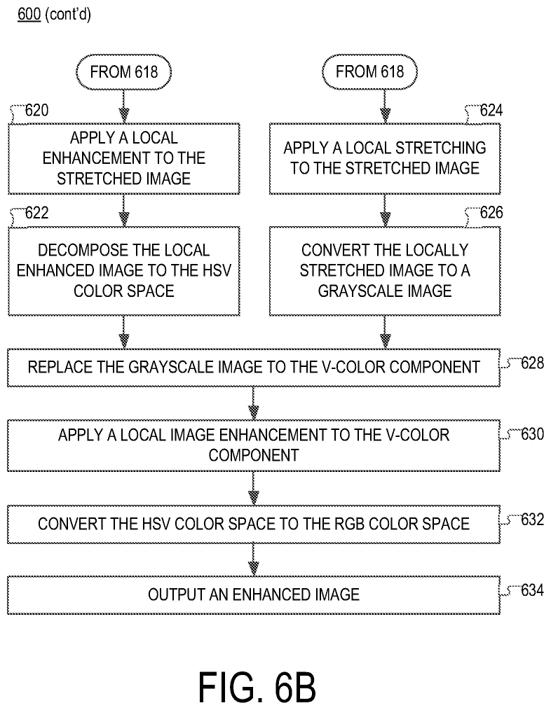

FIGS. 6A-B is a flowchart of an example of a process 600, according to aspects of the disclosure. At step 602, a color image is received as input. In some implementations, the color image may be the same or similar to the image generated at step 416 of the process 400 (shown in FIG. 4). At step 604, the global mean of the image is calculated. At step 606, a determination is made if the global mean is less than or equal to a threshold L. For an illustrative example of fractional stretching functions—see also: T. Trongtirakul, W. Chiracharit, S. Imberman, and S. Agaian, “Fractional Contrast Stretching for Image Enhancement of Aerial and Satellite Images,” Journal of Imaging Science and Technology, vol. 63, no. 6, pp. 60411-1-60411-11, 1 Nov. 2019. If the global mean is less than the threshold L, a set γₙ=[0.1, 0.2, . . . , 1.0] is initialized, at step 608. If the global mean is less than the threshold L, a set γₙ=[1.1, 1.2, . . . , 2.0] is initialized, at step 610. At step 612, fractional stretching parameters are calculated. At step 614, fractional stretching functions are calculated. At step 616, the fractional stretching functions are combined into a single stretching function. At step 618, a stretched image is generated based on the stretching function (generated at step 616). At step 620, a local enhancement is applied to the stretched image. At step 622, the local enhanced image is decomposed to the HSV color space. At step 624, a local stretching is applied to the stretched image. At step 626, the locally stretched image is converted to a grayscale image. At step 628, the V-channel in the HSV image (generated at step 624) is replaced with the grayscale image (generated at step 628). At step 630, a local image enhancement is applied to the V-channel of the image produced at step 630 (i.e., the grayscale image). At step 634, the image resulting after step 632 is executed is converted to the RGB color space to produce an enhanced image. At step 636, the enhanced image is output.

In some implementations, the global mean of the image may be calculated, at step 604, based on Equation A7 below:

$$μ = \frac{1}{N \times M} {\sum }_{i = 1}^{N} {\sum }_{j = 1}^{M} {I}_{i , j} \qquad ( A7 )$$

where I_{i,j} represents an input color image with the size of M by N.

In some implementations, the fractional stretching unction parameters may be defined as follows:

$$t = \frac{1}{2 NM} {\sum }_{i = 1}^{N} {\sum }_{j = 1}^{M} {I}_{i , j} \qquad ( A8 )$$

where I_{i,j} represents an input color image with the size of M by N.

In some implementations, the fractional stretching functions may be calculated, at step 614, as follows:

$${f}_{n} ( x ) = {( \frac{x - {x}_{min}}{{x}_{max} - {x}_{min}} )}^{{γ}_{n}} \qquad ( A9 )$$

$${g}_{n} ( x ) = \frac{1}{1 + {e}^{- {a}_{n} ( x - t )}} \qquad ( A10 )$$

where x denotes the set of luminance levels, {x}={xₘᵢₙ, xₘᵢₙ+1, . . . , xₘₐₓ}, xₘᵢₙ and xₘₐₓ represents the minimum luminance level and the maximum luminance level, respectively. t refers to an image threshold. γₙ is the set of gamma parameters and an is the set of sigmoid parameters.

In some implementations, the fractional stretching functions may be combined, at step 616, as follows:

$${h}_{n} ( x ) = {α}_{n} \cdot {f}_{n} ( x ) + ( 1 - {α}_{n} ) \cdot {g}_{n} ( x ) \qquad ( A11 )$$

$${h}_{n} ( x ) = {f}_{n} ( x ) + {g}_{n} ( x ) - [ {f}_{n} ( x ) {g}_{n} ( x ) ] / {M}_{n} \qquad ( A12 )$$

where αₙ represents the set of non-linear weights. fₙ(x) and gₙ(x) denotes the set of exponential functions and the set of sigmoid functions, respectively. M is a constant, for instance, M=256 in case of an unit8-image.

In some implementations, the single fractional stretching function may be generated as follows:

$$F ( x ) = {ω}_{n} \cdot {h}_{n} ( x ) \qquad ( A13 )$$

where hₙ(x) represents the set of the fractional stretching functions and on denotes the set of fractional weights.

In some implementations, the stretched image may be generated, at step 620, as follows:

$${S}_{i , j} = F ( {I}_{i , j} ) \qquad ( A15 )$$

where I_{i,j} represents an input image and F(⋅) denotes a single stretching function.

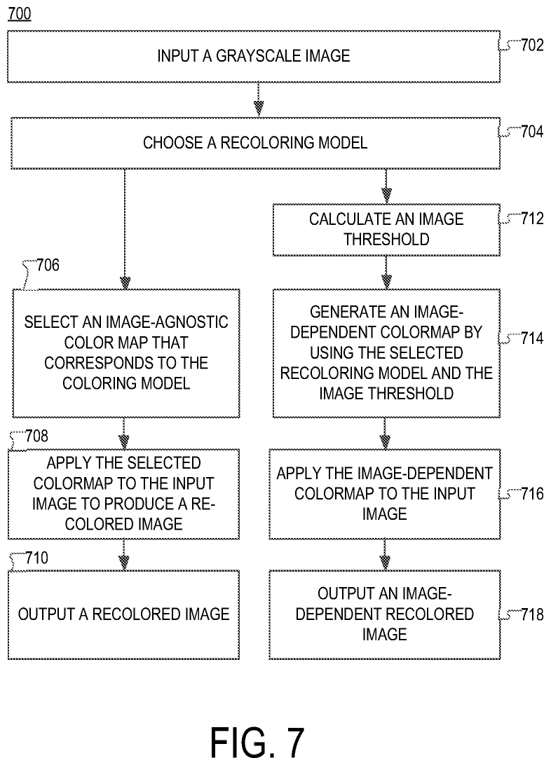

FIG. 7 is a flowchart of an example of a process 700, according to aspects of the disclosure. At step 702, a grayscale image is received as input. At step 704, a recoloring model is selected. At step 706, an image-agnostic color map is selected that corresponds to the selected recoloring model. At step 708, the selected color map is applied to the grayscale image to produce a re-colored image. At step 710, the recolored image (generated at step 708) is output. At step 712, an image threshold is calculated. At step 714, an image-dependent colormap is generated by using the selected recoloring model and the image threshold. At step 716, the image-dependent color map is applied to the grayscale image to produce a re-colored image. At step 718, the recolored image (generated at step 718) is output.

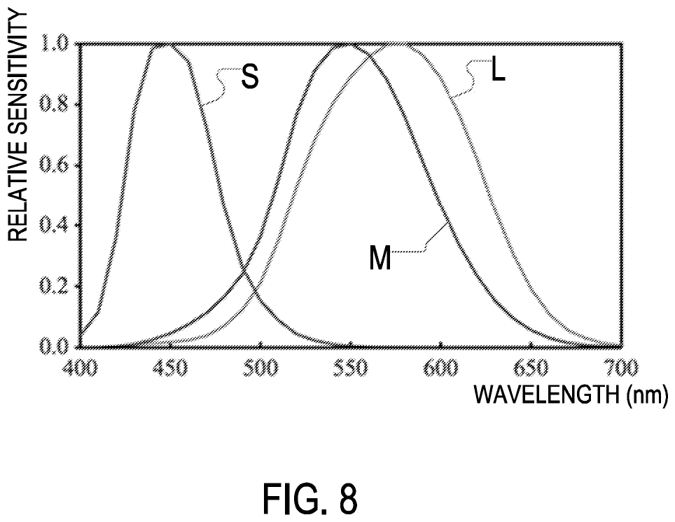

FIG. 8 shows plots of the bands the LMS color-space. As is well-known, the LMS color space represents the response of three different types of cones in the human eye. Conversion from XYZ to LMS is given by:

$$[ \begin{matrix}L \\ M \\ S\end{matrix} ] = [ \begin{matrix}0.3897 & 0.6890 & - 0.0787 \\ - 0.2298 & 1.1834 & 0.0464 \\ 0.0000 & 0.0000 & 1.0000\end{matrix} ] [ \begin{matrix}X \\ Y \\ Z\end{matrix} ]$$

The inverse of which is:

$$[ \begin{matrix}X \\ Y \\ Z\end{matrix} ] = [ \begin{matrix}1.9102 & - 1.1121 & 0.2019 \\ 0.3710 & 0.6291 & 0.0000 \\ 0.0000 & 0.0000 & 1.0000\end{matrix} ] [ \begin{matrix}L \\ M \\ S\end{matrix} ]$$

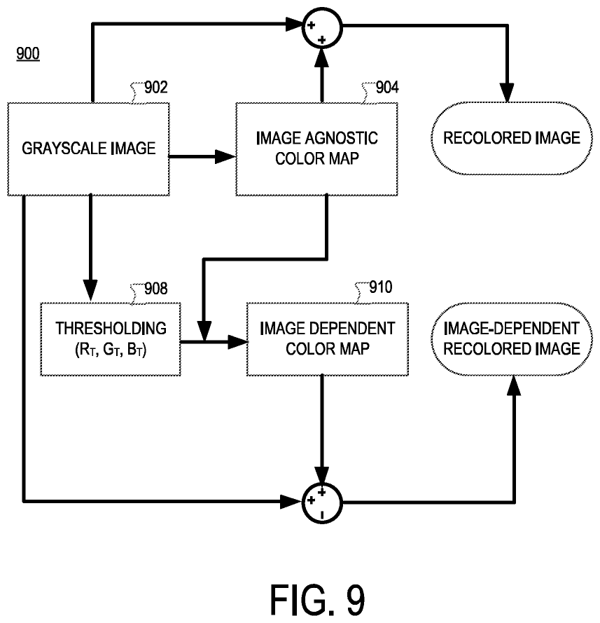

FIG. 9 is a flowchart of an example of a process 900, according to aspects of the disclosure. At step 902, a grayscale image. At step 904, an image agnostic color map is applied to the image to produce a recolored image. At step 908 threshold R_{T}, G_{T}, and B_{T} are calculated. At step 910, an image-dependent color model is generated and applied to the grayscale image to produce a re-colored image.

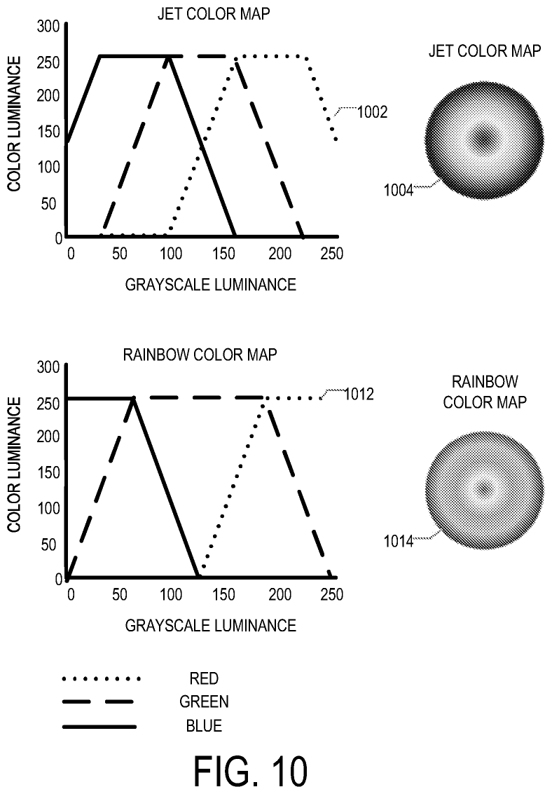

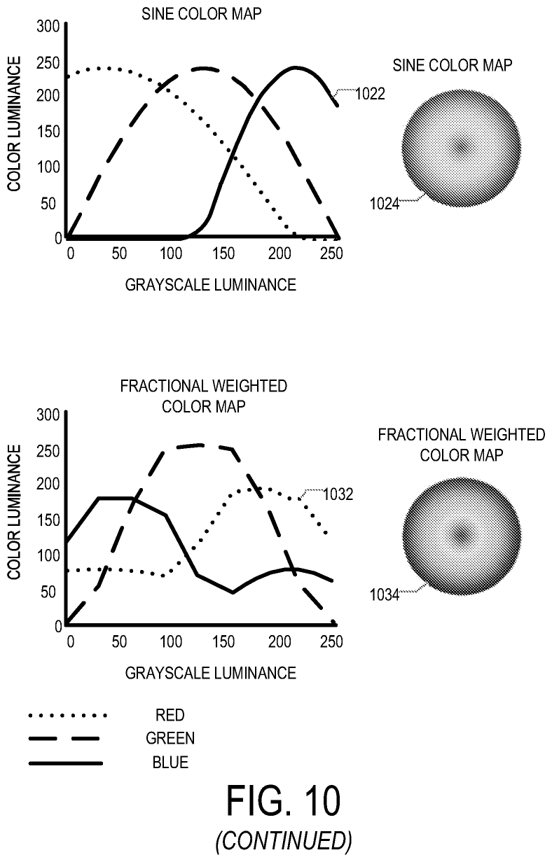

FIG. 10 shows examples of different color maps that can be used in the processes described throughout the disclosure. Shown in FIG. 10 is a jet color map 1002 and a gradient chart 1004 for the jet color map 1002. In addition, shown are: a rainbow color map 1012 and a gradient chart 1014 for the rainbow color map; a sine color map 1022 and a gradient chart 1024 for the sine color map; and fractional weighted color map 1032 and a gradient chart 1034 for the fractional weighted color map 1032.

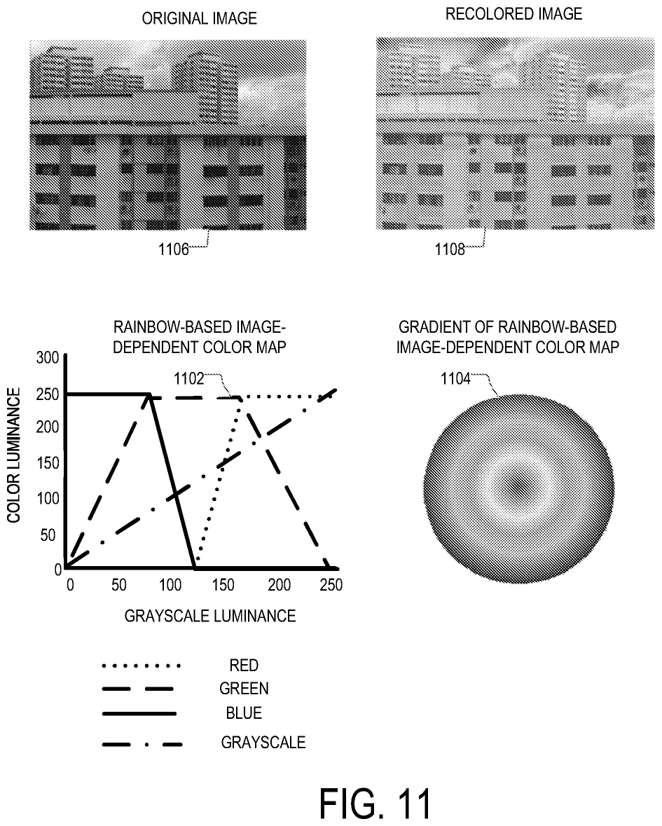

FIG. 11 shows an example of the application of a rainbow-based color map 1102 on an original 1106 to produce a re-colored image 1108. In addition, FIG. 11 shows an example gradient chart 1104 for the rainbow-based color map 1102. In some respects, the original image 1102 may be a grayscale image (or another single-channel and/or single-band image). The re-colored image may have a bluish-greenish appearance that is characterized by a higher contrast than the original image. Re-coloring the original image 1102 in this manner is advantageous in image analysis applications where high contrast is necessary to discern detail in the original image 1102.

FIG. 11 further shows an example of the application of a cosine-based image-dependent color map 1112 on an original 1116 to produce a re-colored image 1118. In addition, FIG. 11 shows an example gradient chart 1114 for the rainbow-based color map 1112. In some respects, the original image 1112 may be a grayscale image (or another single-channel and/or single-band image). The re-colored image may have a yellowish appearance that is characterized by a higher contrast than the original image. Re-coloring the original image 1112 in this manner is advantageous in image analysis applications where high contrast is necessary to discern detail in the original image 1112.

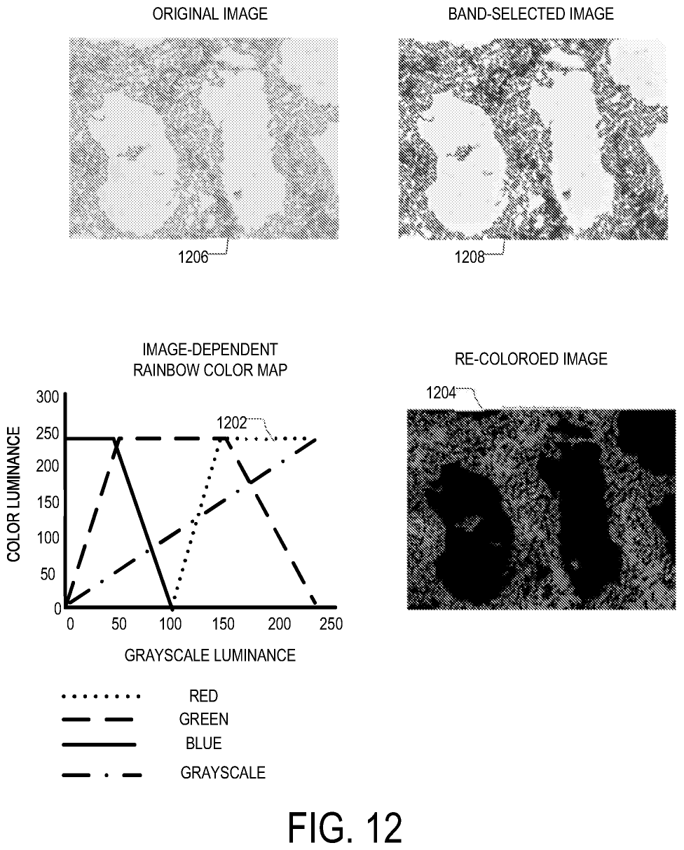

FIG. 12 shows an example of an original image 1206 and a band-selected image 1208 that is generated based on the original image. In addition, FIG. 12 shows an image-dependent rainbow color map 1202 and a re-colored image 1204 that is generated by re-coloring the band-selected image 1208 with the colormap 1202.

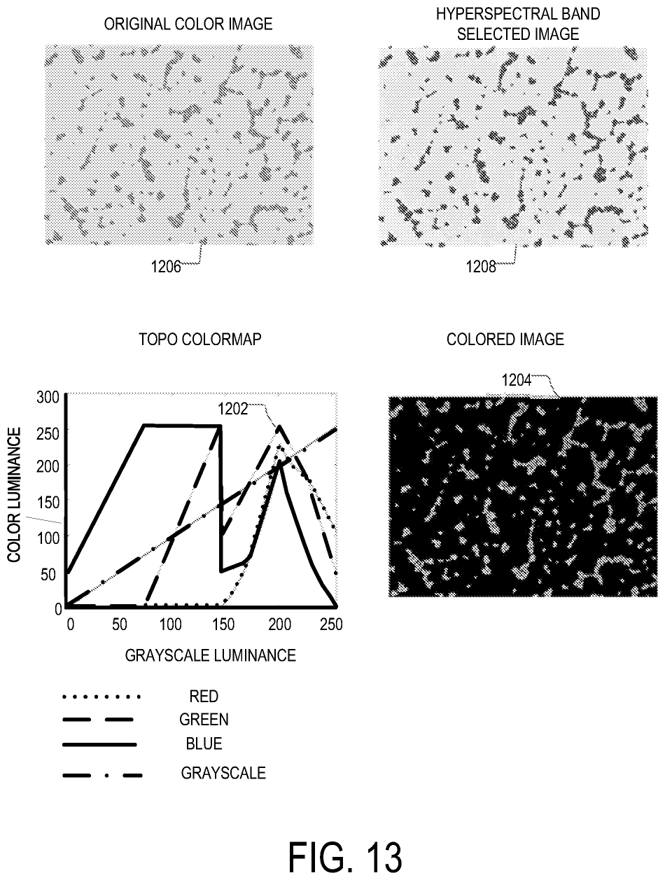

FIG. 13 shows an example of an original image 1306 and a band-selected image 1308 that is generated based on the original image. In addition, FIG. 13 shows an image-dependent topo color map 1302 and a re-colored image 1304 that is generated by re-coloring the band-selected image 1308 with the colormap 1302.

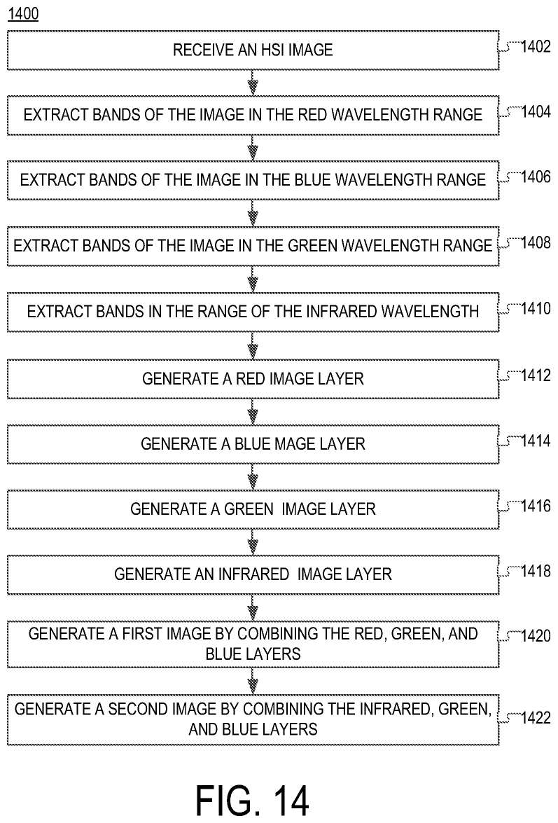

FIG. 14 is a flowchart of an example of a process 1400, according to aspects of the disclosure. At step 1402, an HSI image is received as input. At step 1404, bands of the HSI image that fall in the red wavelength range are extracted. At step 1406, bands of the HSI image that fall in the blue wavelength range are extracted. At step 1408, bands of the HSI image that fall in the green wavelength range are extracted. At step 1410, some or all bands of the HSI image that fall in the infrared wavelength range are extracted. At step 1412, a red image layer is generated based on at least some of the data obtained at steps 1404-1410. At step 1414, a blue image layer is generated based on at least some of the data obtained at steps 1404-1410. At step 1416, a green image layer is generated based on at least some of the data obtained at steps 1404-1410. At step 1418, an infrared image layer is generated based on at least some of the data obtained at steps 1404-1410. At step 1420, a first image is generated by combining the red, green, and blue layers. At step 1422, a second image is generated by combining the red, green, blue, and infrared layers.

In some implementations, some or all of the bands in the HSI image that fall in the red wavelength range may be extracted, at step 1404, as follows:

$${R}_{i , j , λ} = {H}_{i , j , λ} ; λ = [ 610 - 700 nm ] \qquad ( A16 )$$

where H_{i,j,λ} symbolizes the input hyperspectral image containing wavelength (λ) information.

In some implementations, some or all of the bands in the HSI image that fall in the blue wavelength range may be extracted, at step 1406, as follows:

$${B}_{i , j , λ} = {H}_{i , j , λ} ; λ = [ 450 - 500 nm ] \qquad ( A17 )$$

where B_{i,j,λ} symbolizes the part of the input hyperspectral image containing blue wavelength (λ) information.

In some implementations, some or all of the bands in the HSI image that fall in the green wavelength range may be extracted, at step 1408, as follows:

$${G}_{i , j , λ} = {H}_{i , j , λ} ; λ = [ 500 - 570 nm ] \qquad ( A18 )$$

where G_{i,j,λ} symbolizes the part of the input hyperspectral image containing green wavelength (λ) information.

In some implementations, some or all of the bands in the HSI image that fall in the infrared wavelength range may be extracted, at step 1408, as follows:

$${N}_{i , j , λ} = {H}_{i , j , λ} ; λ \geq 700 nm \qquad ( A19 )$$

where N_{i,j,λ} symbolizes the part of the input hyperspectral image containing blue infrared (λ) information.

In some implementations, the red, blue, green, and infrared layers may be generated, in steps 1412-1418, as follows:

$${R}_{i , j} = {ω}_{k} \cdot {R}_{i , j , λ} ; k = c a r d ( λ ) ; λ = [ 610 - 700 nm ] \qquad ( A20 )$$

$${G}_{i , j} = {ω}_{k} \cdot {G}_{i , j , λ} ; k = c a r d ( λ ) ; λ = [ 500 - 570 nm ] \qquad ( A21 )$$

$${B}_{i , j} = {ω}_{k} \cdot {B}_{i , j , λ} ; k = c a r d ( λ ) ; λ = [ 450 - 500 nm ] \qquad ( A22 )$$

$${N}_{i , j} = {ω}_{k} \cdot {N}_{i , j , λ} ; k = c a r d ( λ ) ; λ \geq 700 nm \qquad ( A23 )$$

where R_{i,j,λ}, G_{i,j,λ}, B_{i,j,λ} and N_{i,j,λ} represent a representative color subset. card(⋅) is a cardinality operator (“number of elements” set) and ωₖ denotes a function-based fusion parameter.

In some implementations, the first image may be generated at step 1420, as follows:

$${C}_{i , j , k} = {R}_{i , j} {⋃}_{k} {G}_{i , j} {⋃}_{k} {B}_{i , j} \qquad ( A24 )$$

where [symbol] denotes a union operator in the k-direction. R_{i,j}, G_{i,j} and B_{i,j} represent a red component, a green component, and a blue component, respectively.

In some implementations, the second image may be generated at step 1422, as follows:

$${CI}_{i , j , k} = {N}_{i , j} {⋃}_{k} {G}_{i , j} {⋃}_{k} {B}_{i , j} \qquad ( A25 )$$

where [symbol] denotes a union operator in the k-direction (layer-wise). N_{i,j}, G_{i,j} and B_{i,j} represent the infrared component, the green component, and the blue component, respectively.

### Part B Displaying Hyperspectral Cube Using Band Selection and Recoloring Methods.

B.1 Introduction. A hyperspectral sensor usually may include 200 or more spectral bands. The set of spectral bands are also referred to as a hyperspectral cube and they include bands in the following wavelength ranges: (200-400 nm), visible (400-700 nm), near-infrared (700-1,000 nm), and short-wave infrared (1,000-4,000 nm). A large number of bands signify high-dimensional details introducing several significant challenges to image processing. Those details require storage space, expensive computation, and communication bandwidth that notify against real-time applications. To decrease the size of hyperspectral images, recent research [focuses on reducing those enormous redundant details between bands, and some bands may contain less discriminatory details than others. Therefore, the calculation to select suitable bands is considered by using different criteria.

Band selection can be conducted in a supervised or unsupervised fashion. The supervised methods construct classification criteria. The classification criteria may be used to maximize the class separability of training samples with known class labels. However, because of spectral variability of ground objects in the image scene, different training samples might exhibit divergent spectrum characteristics. That would bring about the instability of the selected band subset from supervised methods. Moreover, the prior knowledge of training samples with class labels is usually unavailable in most scenarios of the HSI data. The above drawbacks adversely restrict the applications and promotions of supervised methods.

Band Selection (BS) can be accomplished by feature classification or feature extraction (also known as Hyper-Spectral Image (HSI) reduction) techniques. The most popular technique for band selection (BS) is principal component analysis (PCA)-based methods. In fact, PCA and other unsupervised BS methods, for instance, Fast Volume-Gradient (FVG), Mutual Information (MI), Group Lasso (GL), enhanced fast density-peak-based clustering (E-FDPC), maximum-variance principal component analysis (MVPCA), Close Range (CR) can be categorized as feature extraction and image classification. Imaging feature extraction and classification extract a set of new essential features from the original hyperspectral cube through a mapping function.

Another class of the BS methods relates to nature-inspired optimizations and supervised-based methods such as Maximal Clique (MC), Multi-Objective Particle Swarm Optimization (PSO) Algorithm and Game Theory, Enhanced Hybrid-Graph Discriminant Learning (EH-GDL). The supervised class is powerful for single-objective and multi-objective optimization problems. However, the BS results are not significantly improved. The supervised-based BS methods take computational complexity.

The aforementioned unsupervised and supervised BS methods are designed for hyperspectral reduction. Advantages and disadvantages of the methods are represented in Table B.I. As indicated by Table B.I, a reduced hyperspectral image still contains many bands. In the field of image enhancement (a commonly used pre-processing method for feature extraction and classification), it requires a few hyperspectral bands, which illustrate good-visualized details. Unfortunately, there is no research or even measures that can choose the best hyperspectral band.

TABLE B.I

| | Hyperspectral Dataset Details | | Wavelengths |
|---|---|---|---|
| Database | Resolution | Spectral Bands | (nm) |
| OS | 1,904 × 1,312 | 49 | 400.00-700.00 |
| UP | 610 × 340 | 103 | 430.00-860.00 |
| KSC | 512 × 614 | 224 | 400.00-2,500.00 |
| Cuprite | 512 × 614 | 176 | 400.00-2,500.00 |

In one aspect the present disclosure focuses on HSI special dimension reduction problem by mapping an HSI image into a color (RGB) image. According to aspects of the disclosure, it has been determined that the HSI hyperspectral image mapping into the RGB color space or a trichromatic display image satisfies information preservation, edge salience, consistent rendering, and natural palette properties.

B.2 Human Visual System-based Hyperspectral Band Selection Measure. In this sub-section, two BS algorithms are provided: i) Single-Band Selection; and ii) Multi-Band Selection.

B.2.a Single-Band Selection Algorithm. The selection of a composition in hyperspectral imaging applications is very important. To choose the best hyperspectral band, a novel band selection measure is proposed. The novel band-selection measure is based on the Weber-Fechner's law and Block-Based Information Entropy (BBIE) concept. The Weber-Fechner's law refers to human perception, more specifically, the relationship between the actual change in a physical stimulus and the perceived change. Weber's Law states that the ratio for Just Noticeable Difference to the background intensity I is a constant. Another part relates to local information. The small local block of local information is more sensitive in changing local details. The combination of both advantages can help detect all local details, which correspond to the human visual system (HVS). The proposed measure for Block-based BS (BBS) can be described as:

$$B B S = \frac{0.5681}{N \cdot M} {\sum }_{i = 1}^{N} {\sum }_{j = 1}^{M} Δ D \cdot log ( \frac{Δ D + c}{{[ {I}_{max} ]}_{i , j}^{m , n} + {[ {I}_{min} ]}_{i , j}^{m , n} + c} ) \qquad ( B1 )$$

$$Δ D = {[ {I}_{max} ]}_{i , j}^{m , n} - {[ {I}_{min} ]}_{i , j}^{m , n} ; Δ D > τ \qquad ( B2 )$$

where N and M represent the size of the hyperspectral image in width and height. m and n denote the size of a local block. [Iₘᵢₙ]_{i,j}^{m,n} and [Iₘₐₓ]_{i,j}^{m,n} are a block-based minimum luminance and a block-based maximum luminance, respectively. c is a small number to avoid the calculation error of a logarithmic function and i is the threshold of human perception, τ refers to the difference between [Iₘₐₓ]_{i,j}^{m,n} and [Iₘᵢₙ]_{i,j}^{m,n}. In our experiments, we set τ=1 on a spatial plain. When projected the difference on a logarithmic plain, log (τ)=log(1)=0. In some respects, the value of BBS for a given band measures the entropy of this band.

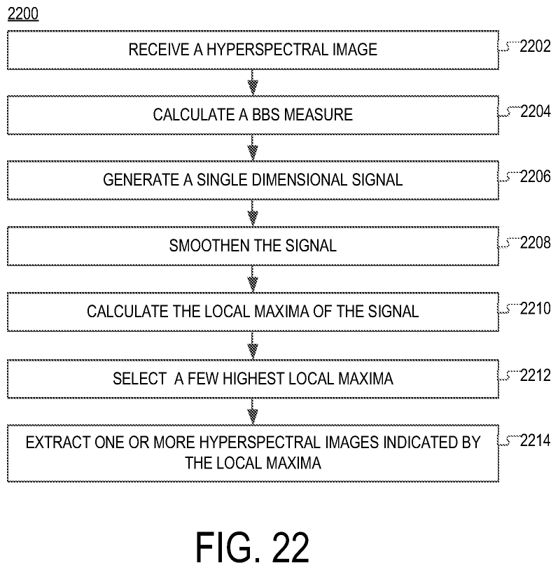

FIG. 22 shows an example of a process 2200 for single-band selection.

At step 2202 a hyperspectral image is received.

At step 2204 a BBS measure is calculated for the received hyperspectral image. The BBS measure may be calculated as discussed above with respect to equations B1 and B2.

At step 2206, a single-dimensional signal is generated that represents the calculated BBS measure.

At step 2208 the single-dimensional signal is smoothened in the direction of the response function of a band selection. In some implementations, the BBS function may be applied for selecting the plurality of the most informative bands (Eq. B1-B2). The smoothening may be performed by using equation (3) below.

$$S ( λ ) = ( H ( λ ) ⊗ f ( x ) ) , … , ⊗ f ( x ) \qquad ( B3 )$$

where S(λ) represents a smooth signal. H(λ) represents a single-dimensional signal. f(x) represents a 1-by-3 median filter, x is the index of the filter. H(λ) represents a single-dimensional signal. The index of signal corresponds to the wavelength of the hyperspectral image, A.

At step 2210, the local maxima of the smooth signal are calculated. The smooth function (i.e., equation B3) is discrete. So, the function must be separated into the interval [xₖ−h, xₖ+h] and calculated as:

$$S ( {λ}_{m} ) \geq S ( {x}_{k} ) ; {x}_{k} \to {λ}_{m} \qquad ( B4 )$$

$$for S ( {x}_{k} - h ) < S ( {λ}_{m} ) for ∀ {x}_{k} < {λ}_{m} \qquad ( B5 )$$

$$and S ( {x}_{k} + h ) < S ( {λ}_{m} ) for ∀ {x}_{k} > {λ}_{m} \qquad ( B6 )$$

where λₘ represents the wavelength, which gives a local maxima number of a function S(xₖ) in the interval [xₖ−h, xₖ+h] for some sufficiently small shifting number h. k represents the number of intervals.

At step 2212, two or more of the highest local maxima are selected. This step determines the number of local maxima points and it can be written as:

$${λ}_{Φ} = {arg max}_{{λ}_{m ∈} [ {x}_{k} - h , {x}_{k} + h ]} S ( {λ}_{m} ) \qquad ( B7 )$$

where λ_{Φ} represents the selected wavelengths. The present example selects three wavelengths that were maximized in three different wavelength regions. Thus, Φ=3. The three selected regions relate to the RGB wavelengths. Specifically, they relate to the following spectral colors: Red, whose wavelength is in the range of 610-700 nm, Green, whose wavelength is in the range of 500-570 nm, and Blue, whose wavelength is in the range of 450-500 nm. (E.g. See Nave, R. “Spectral Colors”. Hyperphysics. Retrieved May 11, 2022.)

$$[ \begin{matrix}{R}_{i , j} \\ {G}_{i , j} \\ {B}_{i , j}\end{matrix} ] = {w}_{λ} \cdot [ \begin{matrix}\{ {I}_{i , j , λ} \vert λ = \{ 610 nm , 700 nm ] \} \\ \{ {I}_{i , j , λ} \vert λ = [ 500 nm , 570 nm ] \} \\ \{ {I}_{i , j , λ} \vert λ = [ 450 nm , 500 nm ] \}\end{matrix} ]$$

where w_{λ} is a weight coefficient (e.g., w_{λ}=1, etc.) For example, if four adjacent bands are taken (two from the left and two from the right as shown in FIG. 5), the possible maximum value of

$${w}_{λ} = \frac{1}{4 + 1} = \frac{1}{four adjacent bands + one center band} .$$

At step 2214, a respective hyperspectral image is extracted that corresponds to each of the local maxima. Each respective hyperspectral image is extracted in accordance with equation B8 below.

$${R}_{i , j , {λ}_{Φ}} = {I}_{i , j , λ} \qquad ( B8 )$$

where λ represents a wavelength. I_{i,j} represents a hyperspectral image. R_{i,j} represents a selected hyperspectral image chosen by local maxima wavelengths (λ_{Φ}).

### B.2.b Computer Simulation Results

In the computer simulation that is discussed in this section, the human threshold (T) is set as 1.0. If there are no differences in a local block, the result of a local block will be zero. The computer simulation is conducted on an iMac with Intel® Core™ i5-4590@3.30 GHz, AMD Radeon R9 M290 Graphical Processing Unit (GPU) and 8 GB of RAM. The computer simulation uses four publicly available hyperspectral image. Four publicly available hyperspectral images datasets are used, namely Outdoor Scenes (OS) (General Scene: https://sites.google.com/site/hyperspectralcolorimaging/dataset/general-scenes.), University of Pavia (UP) (Hyperspectral Remote Sensing Scenes: http://www.ehu.eus/ccwintco/index.php/Hyperspectral_Remote_Sensing_Scenes), Kennedy Space Center (KSC) (Remote Sensing Datasets: https://rslab.ut.ac.ir/data), and Cuprite (Hyperspectral Data: https://www.microiinages.com/downloads/hyperspectal.htm.)

The proposed single-band selection algorithm (discussed with respect to FIG. 22) is compared with conventional BS methods. Each method has different imaging attributes as summarized in Table B.II.

TABLE B.II
Hyperspectral Band Selection Measures

| | |
|---|---|
| Method | Band Selection Measure |
| FVG | High-Dimensional Volume |
| Split & | Correlation |
| Merge | |
| E-FDPC | Enhanced Fast Density-Peak-Based |
| | Clustering |
| MVPCA | Maximum-Variance Principal |
| | Component Analysis |
| Subjective | Mean Opinion Score |
| Proposed | Block-Based Band Selection |

Moreover, the proposed single-band selection algorithm was compared with human perception—subjective evaluation. For the subjective evaluation, it was given a score by several hundred persons. They do not have any visual system problems including color blindness. The visual scores are calculated by using the mean opinion score (MOS) recommended by ITU-T (See Methods for Subjective Determination of Transmission Quality, STU-T Recommendation, pp. 800, 1996.) For the single-band selection, the subjective evaluation shows that the best visualized band is the 44^{th} band (slice). The objective evaluation calculated by the BBS method shows the same band. TABLE B.III confirms that the objective BBS method can be applied for selecting multi-band (slice) of hyperspectral images.

TABLE B.III
Hyperspectral Band Selection and Evaluations

Slice Index/Wavelength (nm)

| | 4^{th} | 9^{th} | 34^{th} | 44^{th} |
|---|---|---|---|---|
| Method | 419.19 | 449.60 | 603.95 | 666.77 |
| FVG | −117.49 | 72.81 | 60.71 | −0.80 |
| Split & Merge | 0.99 | 0.96 | 0.98 | 0.95 |
| E-FDPC | 1.00 | 0.00 | 0.11 | 0.00 |
| MVPCA | 0.80 | 0.87 | 1.57 | 1.56 |
| Subjective | 3.04 | 3.22 | 3.98 | 4.20 |
| (MOS) | | | | |
| Proposed | 2.12 | 2.69 | 4.49 | 4.65 |
| Method | | | | |

Table B.III shows that the proposed BBS measure is more accurate than other methods. Moreover, Table B.III indicates that the best image is in the same index as the proposed measure. For the single-band selection, it shows that the proposed BBS measure is the most accurate when compared with the selection using human analysis as shown in Table B.III. The best wavelength is 666.77 nanometers and is at the 44^{th} slice. A slice may be an image component (or a band) from an HSI cube.

Stated succinctly, Table B.II illustrates that the proposed BBS measure, an example of which is described by Equations B1 and B2 is: i) more robust than other existing methods; ii) more consistent with human selection; and iii) less complex because, unlike some of the existing techniques for band selection, it does not require. iterative processing.

B.2.c Multi-Band Selection for Visualization. As the single-band selection results, the selection of a few images might cause redundancy problems. In case those selected images are in adjacent wavelengths, there is no extremely significant difference. For hyperspectral images, it provides different details according to the properties of physical elements. Different wavelengths also generate different details. That is a reason why the multi-band selection should select images from different wavelengths and far away from the first selection.

The purpose of multi-band selection is to represent the information for each period of wavelengths. The multi-band selection can reduce the redundancy of information in hyperspectral images. This makes data storage and transmission more efficient. In addition, the selection can enhance visualization by fusing a few bands to reconstruct pseudo colors. They can illustrate more important details better than grayscale images.

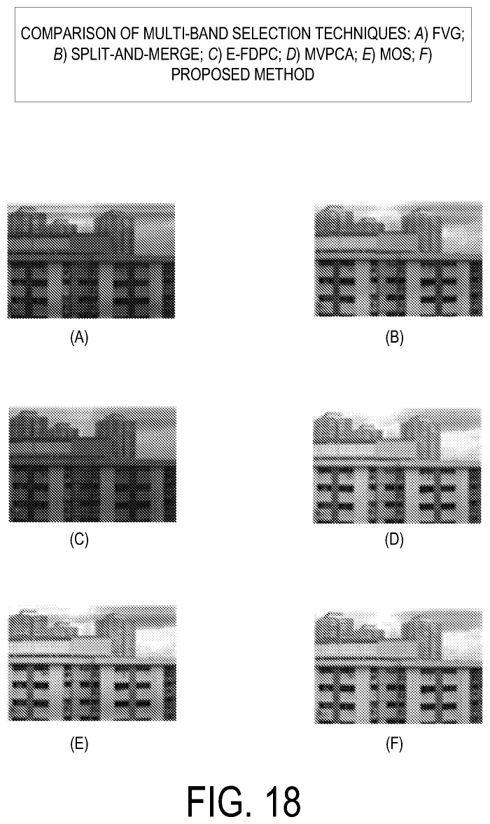

Table IV illustrates the result of a computer simulation for multi-band selection. The multi-band selection is performed by: (1) calculating a different BBS measure for each of a plurality of spectral layers of a hyperspectral image, and (2) selecting more than one of the spectral layers based on the layers' respective BBS measures. The multi-band selection resulting images are shown in FIG. 18 and their evaluation in Table B.IV. The BS by human evaluation chooses adjacent bands. There are no significant difference details among three selected images as shown in FIG. 18, and their contrast number in Table B.IV illustrates no differences in terms of contrast. Our BS method selects the best images from three wavelength periods, which yields different details.

TABLE B.IV
Hyperspectral Band Selection and Evaluations

| Method | First Band | Second Band | Third Band |
|---|---|---|---|
| FVG | 9^{th}: 72.81 | 44^{th}: −0.80 | 40^{th}: −6.70 |
| Split & | 49^{th}: 1.00 | 33^{rd}: 0.97 | 31^{st}: 0.94 |
| Merge | | | |
| E-FDPC | 4^{th}: 1.00 | 48^{th}: 0.35 | 34^{th}: 0.11 |
| MVPCA | 34^{th}: 1.57 | 11^{th}: 1.06 | 28^{th}: 0.97 |
| Subjective | 44^{th}: 4.20 | 40^{th}: 4.20 | 39^{th}: 4.20 |
| FOS | | | |
| Proposed | 35^{th}: 4.49 | 45^{th}: 4.27 | 13^{th}: 2.79 |
| Method | | | |

In another aspect, a digital color system may be used by combining grayscale selected images. As the selected images were taken by three grayscale images, the evaluation of the artificial color image can be calculated as follows:

$$C = {λ}_{R} \cdot BBS ( {R}_{i , j , {λ}_{Φ}} ) + {λ}_{G} \cdot BBS ( {R}_{i , j , {λ}_{Φ}} ) + {λ}_{B} \cdot BBS ( {R}_{i , j , {λ}_{Φ}} ) \qquad ( B9 )$$

where R_{i,j,λ}_{_{Φ}} denotes a selected hyperspectral image chosen by differently local-maxima wavelengths (λ_{Φ}). BBS(⋅) denotes a block-based band selection measure. λ_{R}, λ_{G} and λ_{B} denote a color constant. λ_{R}=0.299, λ_{G}=0.587, and λ_{B}=0.114.

Table B.V compares the performance of the color contrast from combining the selected images with various BS methods that are known in the art. The number as illustrated in Table V presents the contrast of the images. Table B.V illustrates that the proposed multi-band selection tends to increase imaging details and it can be applied for other enhancement purposes.

TABLE B.V
Hyperspectral Band Selection And Evaluations

| | | Split & | | | Proposed |
|---|---|---|---|---|---|
| Dataset | FV | Merge | E-FDPC | MVPCA | Method |
| OS | 0.3191 | 0.0968 | 0.0881 | 0.0843 | 0.1095 |
| KSC | 0.1125 | 0.0048 | 0.0421 | 0.0344 | 0.1722 |
| Cuprite | 0.0000 | 0.3094 | 0.1567 | 0.1131 | 0.3615 |
| UP | 0.1387 | 0.2089 | 0.1958 | 0.1648 | 0.2599 |
| Average | 0.1426 | 0.1550 | 0.1207 | 0.0992 | 0.2258 |

Stated succinctly, the proposed HVS-based hyperspectral band selection measure searches for the best band, which contains most distinctive imaging information. The proposed BS measure calculates the local details by using the Weber-Fechner's law and a BBIE concept. The combination of the law and the concept allows investigating all details under non-uniform luminance conditions. Our computer simulation results from several hundred hyperspectral bands from two databases show that the proposed BS method achieves selecting the best imaging band corresponding to HVS. Also, the proposed method is more accurate than other existing BS methods. The proposed method can be extended to handle well for: i) image enhancement; ii) image classification; iii) grayscale-to-color reconstruction; and iv) HSI representatives. The proposed method can be applied to a wide variety of images and video sequences including artificial intelligent-based applications.

### Part C—Application of Color Maps and Selecting Band

C.1 Introduction. The high-dimensionality of hyperspectral data offers new opportunities for object recognition, classification, and localization. However, high-correlations, volume, and dependencies among hundreds of spectral bands create several main challenges of HSI processing, for instance, storage space, expensive computation, and communication bandwidth. According to the present disclosure, it has been determined that the increment of dimensionalities starts to decrease classification accuracy. The goal of band selection (BS) is to: i) select a small subset of hyperspectral bands; ii) remove spectral redundancy; and iii) reduce computational costs while preserving the essential spectral information of objects.

The display of many HSI bands on a trichromatic (color) monitor is an ongoing research topic. It is related to the HSI dimensionality reduction problem. The hyperspectral representation on a trichromatic display is vital for HSI processing, analysis, and real-time human in-loop application systems. The goal of mapping HSI bands on a given trichromatic monitor is to choose bands and generate a color space based on those chosen bands by preserving critical informative bands and their color image naturalness. The HSI band selection (BS) problem can be mathematically formulated as: mapping a given N×h HSI cube with N bands into k bands that contain the most information, where k<N. The number k of chosen bands is user-defined. The present disclosure considers k=1 and k=3, which corresponds to a trichromatic displaying range of a monitor.

The goal of HSI visualization is to provide i) information as much as possible from original data and facilitate easy image analysis, interpretation, classification; and ii) the ability to utilize the color image processing tools. The commonly used HSI visualization methods can be categorized as spectral transformation methods representing HSI important information, such as principal component analysis (PCA) and noise-adjusted principal component analysis. These methods use the primary R, G, and B color components as the first three principal components of the HSI cube. The current BS methods can be classified into the following classes: a simple visualization method (SWM) (discussed in K. M. Thyng, “The Importance of Colormaps,” in Computing in Science & Engineering, vol. 22, no. 5, pp. 96-102, 1 Sep.-Oct. 2020.), a straightforward method (SM) (discussed in S. Le Moan, et al., “A constrained band selection method based on information measures for spectral image color visualization,” IEEE Trans. Geosci. Remote Sens., 49, no. 12, pp. 5104-5115, 2011), and a perceptual method (PM) (discussed in K. Thilagavathi, and A. Vasuki, “Dimension reduction methods for hyperspectral image: a survey,” International Journal of Engineering and Advanced Technology, vol. 8. no. 2, pp. 160-167, 2018). SWM visualizes an HSI by averaging all bands to produce a grayscale image. This methodology preserves the basic scene structure. However, it suffers from metamerism, which is the same output intensity that assigns different high-dimensional pixel values. SM selects three bands as R, G, and B color model components. PM highlights expected features so that humans can pick up the most informative bands by using software manually. The most existing methods illustrate HSIs in false colors. One essential solution considering HSI visualization is the problem of a particular dimension reduction, which contradicts human experience and expectation. Although HSI visualization constraints are task-dependent, there are some common goals: information preservation, consistent rendering, edge salience, the illustrations of salient features that are not presented in the data and natural palette. The visualization mapping provides high-spectral resolution information to detect and classify targets or objects accurately.

C.2 Hyperspectral Band Selection Techniques. The existing hyperspectral band selection techniques can be classified into two main classes: supervised, and unsupervised methods.

C.2.a Supervised Methods. The application of supervised methods requires class knowledge as a priori, which is often unavailable in many HSI real-time applications. Modern BS methods can be classified into the following several main classes: ranking-based methods, searching-based methods, clustering-based methods, sparsity-based methods, supervised-based methods (for example, a combination method—Support Vector Machine (SVM)) and unsupervised-based methods (for example, feature selection methods—principle component analysis (PCA), Singular Value Decomposition (SVD), Independent Component Analysis (ICA)). The most popular approach for the BS is PCA-based. The PCA is an unsupervised class of the BS method, for instance, Fast Volume-Gradient (FVG) (discussed in X. Geng, et al., “A fast volume-gradient-based band selection method for hyperspectral image,” in IEEE Transactions on Geoscience and Remote Sensing, vol. 52, no. 11, pp. 7111-7119, 2014), Mutual Information (MI) (discussed in B. Guo, et al., “Band selection for hyperspectral image classification using mutual information,” in IEEE Geoscience and Remote Sensing Letters, vol. 3, no. 4, pp. 522-526, October 2006), Group Lasso (GL) (discussed in D. Yang, and W. Bao, “Group lasso-based band selection for hyperspectral image classification,” in IEEE Geoscience and Remote Sensing Letters, vol. 14, no. 12, pp. 2438-2442, December 2017), Enhanced Fast Density Peak-based Clustering (E-FDPC) (discussed in Q. Wang, F. Zhang, and X. Li, “Optimal clustering framework for hyperspectral band selection,” in IEEE Transactions on Geoscience and Remote Sensing, vol. 56, no. 10, pp. 5910-5922, October 2018), maximum-variance principal component analysis (MVPCA) (discussed in Q. Wang, F. Zhang, and X. Li, “Optimal clustering framework for hyperspectral band selection,” in IEEE Transactions on Geoscience and Remote Sensing, vol. 56, no. 10, pp. 5910-5922, October 2018), and Close Range (CR) (discussed in X. Yang, et al., “Research on Dimensionality Reduction of Hyperspectral Image under Close Range,” International Conference on Communications, Information System and Computer Engineering (CISCE), Haikou, China, pp. 171-174, July 2019). In general, supervised band selection methods typically have better performances compared to unsupervised ones. However, supervised approaches require labeled training data, which are very expensive and sometimes difficult to gather.

C.2.b Unsupervised Methods: The goal of unsupervised band selection is to find an “informative” subset of bands from the whole cube using a cost selection measure (specific optimization objectives). The benefits of the unsupervised methods are computationally inexpensive and less complex than supervised band selection methods. For example, Sun et al. present a band selection method based on sparse representation methods (e.g., see K. Sun, X. Geng, and L. Ji, “Exemplar component analysis: A fast band selection method for hyperspectral imagery,” IEEE Geosci. Remote Sens. Lett., vol. 12, no. 5, pp. 998-1002, May 2015). Zhu et al. utilized the structure-aware-based measure to selection informativeness and independence band (e.g., see G. Zhu, et al., “Unsupervised hyper-spectral band selection by dominant set extraction,” IEEE Trans. Geosci. Remote Sens., vol. 54, no. 1, pp. 227-239, 2016). Geng et al. use a simplex volume gradient-based method to remove redundant bands (e.g., see X. Geng, et al., “A fast volume-gradient-based band selection method for hyperspectral image,” in IEEE Transactions on Geoscience and Remote Sensing, vol. 52, no. 11, pp. 7111-7119, 2014). The main disadvantages of the HSI dimensionality reduction and visualization methods mentioned above are the loss of information, the band selection measure, and the higher computational complexity.

As discussed above with respect to Part B of this disclosure, one solution could be developed by a new simple image-driven and unsupervised HVS-based selection measure that automatically chooses the user-needed number of bands. The developing measure facilitates: i) handling of different generated HSI scenarios, for example, low-contrast, i.e., flat, ultra-dark, or ultra-bright cases; ii) the provision of a good color visualization map dedicated to the unreduced (raw) spectral data; iii) the preservation of maximum hyperspectral details with minimal information loss including edge salience, consistent rendering, and natural palette properties; and iv) the display HSI information in color because of the different scene elements as distinctive as possible for further analysis and understanding.

This part of the present disclosure provides a framework for mapping an HSI cube into a trichromatic displaying range of a monitor, which does not require the use of training or training samples. The framework includes a proposed method for band selection, and several proposed methods for color mapping. The proposed methods for color mapping include a so-called VisMap method, a so-called TopoMap method, and a so-called RainbowMap method.

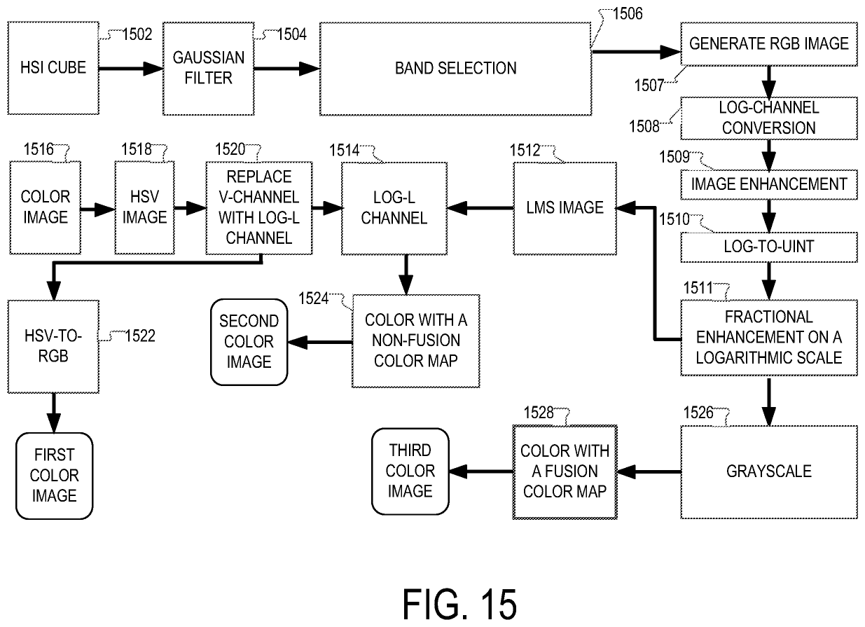

C.2.b Methodology: A proposed framework is introduced for visualizing hyperspectral images using band selection and recoloring for a trichromatic display. The key steps of the proposed framework, as shown in FIG. 15, are i) a band selection algorithm, ii) a fractional contrast enhancement algorithm; and iii) the luminance calculation for recoloring.

FIG. 15 is a flowchart of a process for visualizing HSI images using band selection and recoloring. At step 1502, an HSI cube is received as input. At step 1504, the HSI cube is filtered using a Gaussian filter. At step 1506, one or more bands of the HSI cube are selected. At step 1507, an RGB image is generated based on the selected bands. Generating the RGB image may include designating each of the selected bands as a red, green, and blue channel respectively. At step 1508, a log-channel conversion is performed on the RGB image. At step 1509, image enhancement is performed on the converted image (obtained at step 1809) to improve contrast. At step 1510, log-to-unsigned-integer conversion is performed on the enhanced image. At step 1511, fractional enhancement is performed on the image (obtained at step 1510) on a logarithmic space. Specifically, at step 1511 a fractional function is used to normalize global luminance by adjusting estimated grayscale intensities to the middle range of a luminance level of the image. At step 1512, the image (enhanced at step 1511) is converted to the LMS color space. At step 1514, the logarithmic of the L-channel of the LMS image (produced at step 1512) is obtained. In some implementations, a gamma-rooting approach is applied to the image on a logarithmic plane. At step 1516, a color image is obtained. The color image may be an image of the same scene as the HSI cube (obtained at step 1502). The color image may be obtained by extracting RGB channels from the HSI cube or by using a separate sensor. At step 1518, the color image is converted to the HSV color space. At step 1520, the V-channel of the HSV image (generated at step 1518) is replaced with the logarithmic of the L-channel of the LMS image (generated at step 1512). At step 1522 the HSV image (resulting from the execution of step 1520) is converted to the RGB color space to produce a first color image. At step 1524, the logarithmic of the L-channel of the LMS image is colored with a non-fusion map color map to produce a second color image. Although in the present example, the logarithmic of the L-channel of the LMS image is colored with a non-fusion map, alternative implementations are possible in which the image is colored with a fusion map. At step 1526, the RGB image enhanced (at step 1511) is converted to grayscale. At step 1528, the grayscale image (produced at step 1526) is colored with a fusion map to produce a third color image. Examples of fusion and non-fusion maps that can be used to color the images at steps 1524 and 1528 are discussed with respect to equations C13.01-C22, which are discussed further below. For instance, the VisMap fusion map discussed with respect to equations C13.01-C13.03 may be used to color the image at step 1528.

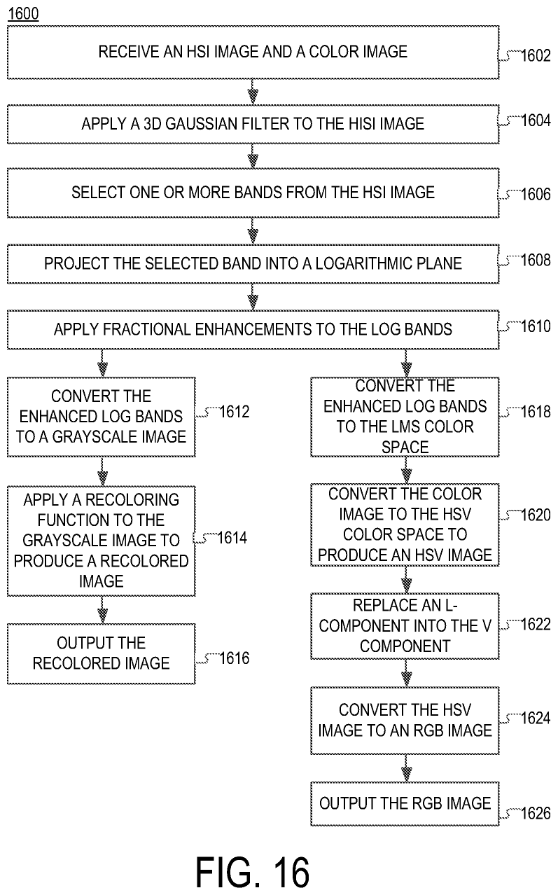

FIG. 16 is a flowchart of an example of a process 1600, according to aspects of the disclosure. At step 1602, an HSI image and a color image are received as input. As noted above, the received HSI image may also be referred to as an HSI cube. At step 1604, a 3D Gaussian filter is applied to the HSI image. At step 1606, one or more bands are selected from the HSI image. At step 1608, each of the selected bands is projected onto a logarithmic plane to produce a respective log band. At step 1610, fractional enhancement is applied to each of the log bands. At step 1612, the enhanced log bands are converted to a grayscale image. At step 1614, a recoloring function is applied to the grayscale image to produce a recolored image. At step 1616, the recolored image is output. At step 1618, the enhanced log bands are converted to the LMS color space to produce an LMS image. At step 1620, the input color image is converted to the HSV color space to produce an HSV image. At step 1622, the L-component (or L-channel) of the LMS image is replaced into the HSV image to produce a resultant HSV image. At step 1624, the resultant HSV image is converted to the RGB color space to produce an RGB image. At step 1626, the RGB image is output. Some of the steps of the process 1600 are discussed in more detail further below:

Band Selection (step 1606): The selection of the perfect composition in HSI applications is critical. Our BS method is an essential step. It locally evaluates each band so that the least relevant bands can be removed later. While no universal metric exists in assessing the significance of bands, according to the present disclosure, it has been determined that the proposed block-based band selection (BBS) measure can select the informative hyperspectral band, which is based on the Weber-Fechner's law and Block-Based Information Entropy (BBIE) concept. Weber-Fechner's law refers to human perception, specifically the several relationships between i) actual change in a physical stimulus and the perceived change—the smallest amount by which a stimulus must be changed to make it perceptibly stronger or weaker; ii) the discrimination threshold, ΔI and the based intensity, I; and iii) stimulus and perception are logarithmic. Finally, Weber-Fechner's law closely relates to the perceptual response that plays a role in the signal detection theory. Also, the small local block of local information is more sensitive in changing local details. The proposed BBS measure considers all informative conditions. It can be written as:

$${BBS}_{λ} = \frac{0.5681}{N \cdot M} {\sum }_{i = 1}^{N} {BBS}_{i , j , λ} \qquad ( C1 )$$

$${BBS}_{i , j , λ} = {\sum }_{j = 1}^{M} Δ D \cdot log ( \frac{Δ D + c}{{[ {I}_{m ax} ]}_{i , j , λ}^{m , n} + {[ {I}_{m i n} ]}_{i , j , λ}^{m , n} + c} ) \qquad ( C2 )$$

$${Δ D = {[ {I}_{ma x} ]}_{i , j , λ}^{m , n} - \{ {I}_{m i n} ]}_{i , j , λ}^{m , n} ; Δ D > τ \qquad ( C3 )$$

where N and M represent the size of the hyperspectral image in width and height. m and n denote the size of a local block. [Iₘᵢₙ]_{i,j,λ}^{m,n} and [Iₘₐₓ]_{i,j,λ}^{m,n} are a block-based minimum luminance and a block-based maximum luminance, respectively. c is a small number to avoid the calculation error of a logarithmic function, and i is the threshold of human perception.

The BBS ranks all hyperspectral bands. It can be selected by taking the highest-ranked band and its several neighbor bands. Most informative selected bands are constructed by neighbor bands-based operations. This construction can reduce Gaussian noise. It can be described as:

$${A}_{i , j} = \{ \begin{matrix}\frac{1}{2 k + 1} {\sum }_{λ = 1}^{2 k} ( {l}_{i , j , λ} \cdot {ω}_{λ \pm k} ) , \sum λ \leq 100 \\ \frac{1}{2 k + 1} {\sum }_{k = 1}^{2 k + 1} {I}_{i , j , λ} + \vert {I}_{i , j , λ} - {I}_{i , jλ \pm k} \vert , \sum λ > 100\end{matrix} \qquad ( C4 )$$

where k represents the band order around the selected band, I_{i,j,λ}.

Fractional Image Enhancement (step 1610): Selected hyperspectral bands contain different details with various intensities. Image enhancement is a crucial tool to increase contrast and details. Occasionally, an image enhancement algorithm could bring some artifacts, for example, a blocking effect due to an image compression process. To avoid unpleasant artifacts, the fractional enhancement algorithm attempts to balance good contrast and local details. The proposed fractional enhanced HSI can be computed by:

$${F}_{i , j , λ} = α E ( {I}_{i , j , λ}^{Lo g} ) + ( 1 - α ) L ( {I}_{i , j , λ}^{Lo g} ) \qquad ( C5 )$$

$${I}_{i , j , λ}^{L og} = {log}^{γ} ( \frac{{I}_{i , j , λ}}{{L}_{m ax}} ) \qquad ( C6 )$$

where E(⋅) represents a global enhancement function. L(⋅) represents a local enhancement function. α represents a weight. γ represents a brightness level factor and Lₘₐₓ represents the maximum luminance level of selected bands, I_{i,j,λ}, i, j refers to a two-dimensional index of an image, and A represents an index of a color component like red, green, and blue, but A-components are chosen from a hyperspectral image, which contains several hundred wavelength components using the techniques described throughout the disclosure (and/or any other suitable technique).

Global Enhancement Function: This function transforms non-uniform luminance to uniform luminance distribution. The operation carries out normalized brightness, passing through a nonlinear correction. The luminance results can be normalized by adjusting the fractional weight in each correction function. The global enhancement function can be computed by:

$$E ( x ) = \frac{1}{N} {\sum }_{a = 1}^{N} {{w}_{a} ( \frac{x - {x}_{m i n}}{{x}_{ma {x}^{- x} m i n}} )}^{{γ}_{a}} \qquad ( C7 )$$

$${γ}_{a} = \{ \begin{matrix}0 \text{.1} , 0.2 , … , 1. , μ < \frac{L}{2} - 1 \\ 1 \text{.0} , 1.1 , … , 2. , μ \geq \frac{L}{2} - 1\end{matrix} \qquad ( C8 )$$

where wₐ represents a fractional weight, Σₐ₌₁^{N} wₐ=1. N represents the total number of fractional weights. x represents a luminance level. xₘᵢₙ and xₘₐₓ represent the minimum and maximum luminance levels, respectively. μ represents a global average luminance level, and L represents the total number of luminance levels in an acceptable range.

Local Enhancement Function: This function performs to increase local details by adjusting each pixel-level luminance. The thin edges and finely detailed visualization in both local dark and bright local regions are improved simultaneously. The local enhancement function can be described by:

$$L ( x ) = {[ {x}_{m ax} ]}_{m , n} {( \frac{{x}_{m , n} - {[ {x}_{m i n} ]}_{m , n}}{{[ {x}_{ma x} ]}_{m , n} - {[ {x}_{m i n} ]}_{m , n}} )}^{{δ}_{x}} \qquad ( C9 )$$

where x_{m,n} represents the local block-based luminance level in any local blocks [m, n]. δₓ represents a local enhancement factor. [xₘᵢₙ]_{m,n} and [xₘₐₓ]_{m,n} represent the local block-based minimum and local maximum luminance level, representatively.

Luminance Calculation: The goal of luminance calculation is to obtain a uniform luminance image from selected bands. A luminance component can be calculated via different two-color spaces: XYZ color space and L*a*b* color space. XYZ color space combines the standard color matching function to the color stimulus under observation. XYZ suffers from the luminance, Y, does not include nonlinear response and the chromatic plane is not perceptually uniform. Another, L*a*b* color space, has nonlinear responses related to human perception. However, L*a*b* is always necessary to select a white point passed through XYZ color space. To generate a perceptual luminance component, we: i) applied two aforementioned color spaces for uniform luminance outcome; and ii) projected the L*a*b* components on a logarithmic plane. The proposed conversion can be defined by:

$$[ \begin{matrix}{ℒ}_{i , j} \\ {𝒶}_{i , j} \\ {i , j}_{}\end{matrix} ] = [ \begin{matrix}1 & 1 & 1 \\ 1 & 1 & - 2 \\ 1 & - 1 & 0\end{matrix} ] [ \begin{matrix}log ( {L}_{i , j} ) \\ log ( {M}_{i , j} ) \\ log ( {S}_{i , j} )\end{matrix} ] \qquad ( C10 )$$

$$[ \begin{matrix}{L}_{i , j} \\ {M}_{i , j} \\ {S}_{i , j}\end{matrix} ] = [ \begin{matrix}0.3897 & 0.689 & - 0.0787 \\ - 0.2298 & 1.1834 & 0.0464 \\ 0 & 0 & 1.\end{matrix} ] [ \begin{matrix}{X}_{i , j} \\ {Y}_{i , j} \\ {Z}_{i , j}\end{matrix} ] \qquad ( C11 )$$

$$[ \begin{matrix}{X}_{i , j} \\ {Y}_{i , j} \\ {Z}_{i , j}\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] [ \begin{matrix}{I}_{i , j , λ = 1} \\ {I}_{i , j , λ = 2} \\ {I}_{i , j , λ = 3}\end{matrix} ] \qquad ( C12 )$$

where I_{i,j,λ} represents the selected bands.

Image Static-Recoloring (step 1614): Color mapping functions drive information more understanding when illustrated because those functions transform data values to perceptual colors. For HSI presentation, the grayscale is not the best option for displaying topography and bathymetry. The use of different colormaps allows for tailoring the color map to each objective's unique properties. Rainbow-based color maps are an excellent choice for data presentation in some conditions such as terrain, building, roads, and water. Rainbow-based maps are discussed in M. Borkin et al., “Evaluation of artery visualizations for heart disease diagnosis,” IEEE Trans. Vis. Comput. Graph., vol. 17, no. 12, pp. 2479-2488, December 2011. Drawbacks of rainbow-based color maps include that: i) some color spectrums do not balance, and ii) fake gradients are added while obscuring details.

According to the present disclosure, a set of color maps is proposed that lacks some of the disadvantages of color maps that are known in the art, such as rainbow-based color maps. The proposed color maps aim to: i) balance transitional colors between blue and red; ii) jump in perceptual uniformity. The proposed color maps can be calculated by:

$${R}_{F} ( x ) = {β}_{1} {R}_{J} ( x ) + {β}_{2} {R}_{P} ( x ) + ( 1 - {\sum }_{i} {β}_{i} ) {R}_{R} ( x ) \qquad ( C13 \text{.1} )$$

$${G}_{F} ( x ) = {β}_{1} {G}_{J} ( x ) + {β}_{2} {G}_{P} ( x ) + ( 1 - {\sum }_{i} {β}_{i} ) {G}_{R} ( x ) \qquad ( C13 \text{.2} )$$

$${B}_{F} ( x ) = {β}_{1} {B}_{J} ( x ) + {β}_{2} {B}_{P} ( x ) + ( 1 - {\sum }_{i} {β}_{i} ) {B}_{R} ( x ) \qquad ( C13 \text{.3} )$$

$${R}_{j} ( x ) = \{ \begin{matrix}{L}_{m i n} , & x \leq {x}_{3} \\ c ( x - {x}_{3} ) , & {x}_{3} < x \leq {x}_{5} \\ {L}_{m a x} , & {x}_{5} < x \leq {x}_{7} \\ - c ( x - {x}_{7} ) + {L}_{m ax} , & x > {x}_{7}\end{matrix} \qquad ( C14 )$$

$${G}_{J} ( x ) = \{ \begin{matrix}{L}_{m i n} , & x > {x}_{7} ; x \leq {x}_{1} \\ c ( x - {x}_{1} ) ; & {x}_{1} < x \leq {x}_{3} \\ {L}_{m ax} , & {x}_{3} < x \leq {x}_{5} \\ - c ( x - {x}_{5} ) + {L}_{m ax} , & {x}_{3} < x \leq {x}_{7}\end{matrix} \qquad ( C15 )$$

$${B}_{J} ( x ) = \{ \begin{matrix}cx + 131.48 , & x \leq {x}_{1} \\ {L}_{m ax} , & {x}_{1} < x \leq {x}_{3} \\ - c ( x - {x}_{3} ) + {L}_{m ax} , & {x}_{3} < x \leq {x}_{5} \\ {L}_{m i n} , & x > {x}_{5}\end{matrix} \qquad ( C16 )$$

$${R}_{R} ( x ) = \{ \begin{matrix}{L}_{m i n} , & x \leq {x}_{4} \\ c ( x - {x}_{4} ) - 2 , & {x}_{4} < x \leq {x}_{6} \\ {L}_{m a x} , & x > {x}_{6}\end{matrix} \qquad ( C17 )$$

$${G}_{R} ( x ) = \{ \begin{matrix}cx , & x \leq {x}_{2} \\ {L}_{ma x} , & {x}_{2} < x \leq {x}_{6} \\ - c ( x - {x}_{3} ) + {L}_{m ax} , & x > {x}_{6}\end{matrix} \qquad ( C18 )$$

$${B}_{R} ( x ) = \{ \begin{matrix}{L}_{m ax} , & x \leq {x}_{2} \\ - c ( x - {x}_{2} ) + {L}_{ma x} + 2 , & {x}_{2} < x \leq {x}_{4} \\ {L}_{m i n} , & x > {x}_{4}\end{matrix} \qquad ( C19 )$$

$${R}_{P} ( x ) = \{ \begin{matrix}{L}_{ma x} \cdot cos ( 29 ( x - 36 ) ) , & x \leq 0.83 L \\ {L}_{m i n} , & x > 0.83 L\end{matrix} \qquad ( C20 )$$

$${G}_{P} ( x ) = {L}_{ma x} \cdot sin ( 40 ( x - 36 ) ) \qquad ( C21 )$$

$${B}_{P} ( x ) = \{ \begin{matrix}{L}_{m i n} , & x \leq 0.49 L \\ {L}_{ma x} \cdot cos ( x + 145 ) , & x > 0.49 L\end{matrix} \qquad ( C22 )$$

where β₁ and β₂ represent the weights of a color map. Lₘᵢₙ and Lₘₐₓ represent the minimum and maximum color luminance levels, respectively. x represents a grayscale luminance level (or the level of another type of pixel in a single-channel image). L represent the total number of luminance levels of the grayscale image (for 8-bit grayscale image case L=256) or entropy. c represents a color constant, c=4, and xᵢ represents a grayscale luminance threshold, x_{i=1,2, . . . , 7}=(iL/8)−1.

IMAGE DEPENDENT-RECOLORING: The x₁, x₂, . . . , x₇ is calculated by the L²-Entropy, or KL²-Threshold (S. Benbelkacem, A. Oulefki, S. Agaian, N. Zenati-Henda, T. Trongtirakul, D. Aouam, M. Masmoudi, and M. Zemmouri, “COVI3D Automatic COVID-19 CT Image-Based Classification and Visualization Platform Utilizing Virtual and Augmented Reality Technologies,” Diagnostics, vol. 12, no. 3, 649, 2022, doi: 10.3390/diagnostics12030649.)

Double Logarithmic Entropy (L²-Entropy): L²-Entropy is defined as:

$${T}_{L} = arg {max}_{t} \{ {s}_{1} ( t ) + {s}_{2} ( t ) \}$$

$${s}_{1} ( t ) = {( {h}_{l} ( t ) + 1 )}^{γ} cos ( log ( log ( {h}_{l} ( t ) + 1 ) ) ) ;$$

$${s}_{2} ( t ) = {( {h}_{u} ( t ) + 1 )}^{γ} cos ( log ( log ( {h}_{u} ( t ) + 1 ) ) )$$

$${h}_{l} ( t ) = {\sum }_{s} {\sum }_{t = 1}^{t = n} ( H ( s , t ) ) ;$$

$${h}_{u} ( t ) = {\sum }_{s} {\sum }_{t = n + 1}^{t = L} ( H ( s , t ) ) ;$$

$$H ( s , t ) = card ( {P}_{i , j} )$$

where P_{i,j} represents a paired image between a given image, X_{i,j}, and a denoised image. H(s, t) denotes a matched histogram on a 2D luminance plain, x₀≤s, t≤x_{L-1}.

KL²-Threshold is a combination of Kapur's threshold and the Double Logarithmic threshold:

$$T = arg {max}_{t} ( λ \cdot {T}_{K} + {T}_{L} ( 1 - λ ) \cdot [ \frac{{T}_{K} {T}_{L}}{max \{ {T}_{k} , {T}_{L} \}} ] ) ; 0 \leq λ \leq 1$$

where T_{K} and T_{L} respectively denote the Kapur's threshold and the double logarithmic threshold, and A represents a threshold weight.

Equations C14, C15, and C16 define a jet color map. In a jet color map, the transitions from blue-to-green and green-to-red are narrow. Some luminance levels are represented by a small region, and blue and red regions are color-saturated due to a wide range. Specifically, equation C14 defines the red channel of the color model of the jet color map; equation C15 defines the green channel of the color model of the jet color map; and equation C16 defines the blue channel of the jet color map.

Equations C17, C18, and C19 define a rainbow color map. In a rainbow color map, the transitions are linear. The cosine color model attempts to the width of all color spectrums. Specifically, equation C17 defines the red channel of the color model of the rainbow color map; equation C18 defines the green channel of the color model of the rainbow color map; and equation C19 defines the blue channel of the rainbow color map.

Equations C20, C21, and C22 define a sine color map. In a sine color map, the transitions are linear. The sine color model attempts to equalize the width of all color spectrums Specifically, equation C17 defines the red channel of the color model of the sine color map; equation C18 defines the green channel of the color model of the sine color map; and equation C19 defines the blue channel of the sine color map.

Equations C13.1, C13.2, and C13.2 define a VisMap color map. The VisMap color map reduces the range of cyan (transition of blue-to-green) and the range of yellow (transition of green-to-red). According to the present disclosure, it has been determined that the VisMap color map can increase color-contrast. The VisMap color map is an example of a fusion color map. Specifically, equation C13.1 defines the red channel of the color model of the VisMap color color map; equation C13.2 defines the green channel of the color model of the VisMap color map; and equation C13.3 defines the blue channel of the VisMap color map.

C.3 Computer Simulation Results. The proposed methods are now compared with several conventional BS approaches, such as Fast Volume-Gradient (FVG) (discussed in X. Geng, et al., “A fast volume-gradient-based band selection method for hyperspectral image,” in IEEE Transactions on Geoscience and Remote Sensing, vol. 52, no. 11, pp. 7111-7119, 2014), Split & Merge (SM) (discussed in S. Rashwan, and N. Dobigeon, “A split-and-merge approach for hyperspectral band selection,” in IEEE Geoscience and Remote Sensing Letters, vol. 14, no. 8, pp. 1378-1382, August 2017), Enhanced Fast Density-Peak-based Clustering (E-FDPC) (discussed in Q. Wang, F. Zhang, and X. Li, “Optimal clustering framework for hyperspectral band selection,” in IEEE Transactions on Geoscience and Remote Sensing, vol. 56, no. 10, pp. 5910-5922, October 2018), and Maximum-Variance Principal Component Analysis (MVPCA) (discussed in Q. Wang, F. Zhang, and X. Li, “Optimal clustering framework for hyperspectral band selection,” in IEEE Transactions on Geoscience and Remote Sensing, vol. 56, no. 10, pp. 5910-5922, October 2018) including the subjective evaluation by Mean Opinion Score (MOS) (discussed in W. Sun and Q. Du, “Hyperspectral Band Selection: A Review,” in IEEE Geoscience and Remote Sensing Magazine, vol. 7, no. 2, pp. 118-139, June 2019).

Four HSI datasets were used to evaluate the performance of different BS methods and visualization methods. Two remote-sensing HSI datasets were taken over the Pavia Center and University by the ROSIS sensor. The number of spectral bands is 102 for Pavia Center and 103 for Pavia University. Each band image has a size of 1095×715 for Pavia Center and 610×340 for Pavia University. The second dataset was captured by the Airborne Visible/Infrared Imaging Spectrometer (AVIRIS) over the Kennedy Space Center (KSC), Florida. AVIRIS acquired data in 224 bands, and each band has a size of 512×614. Finally, the last dataset was provided by the HyMap airborne hyperspectral imaging sensor over Cooke City, Montana. HyMap captured data in 126 bands, and each band has a size of 280×800.

Table I below illustrates the overview score, comparing the proposed BS method with existing BS methods and the MOS evaluation. It confirms that the proposed BS method can choose the most informative band, corresponding to human perceptual selection.

TABLE C.I
Hyperspectral Band Selection And Evaluations

Slice Index/Wavelength in nanometer

| | 4^{th} | 9^{th} | 34^{th} | 44^{th} |
|---|---|---|---|---|
| | 419.19 | 449.60 | 603.95 | 666.77 |
| FVG | −117.49 | 72.81 | 60.71 | −0.80 |
| Split & | 0.99 | 0.96 | 0.98 | 0.95 |
| Merge | | | | |
| E-FDPC | 1.00 | 0.00 | 0.11 | 0.00 |
| MVPCA | 0.80 | 0.87 | 1.57 | 1.56 |
| Subjective | 3.04 | 3.22 | 3.98 | 4.20 |
| (MOS) | | | | |
| Proposed | 2.12 | 2.69 | 4.49 | 4.65 |
| Method | | | | |

Single-Band Selection: The selection of the most informative band is challenging for HSI representation. No band selection method can choose the band corresponding to human preference and perception. In this sub-section, the proposed BS method's performance is compared with existing BS methods and human selection.

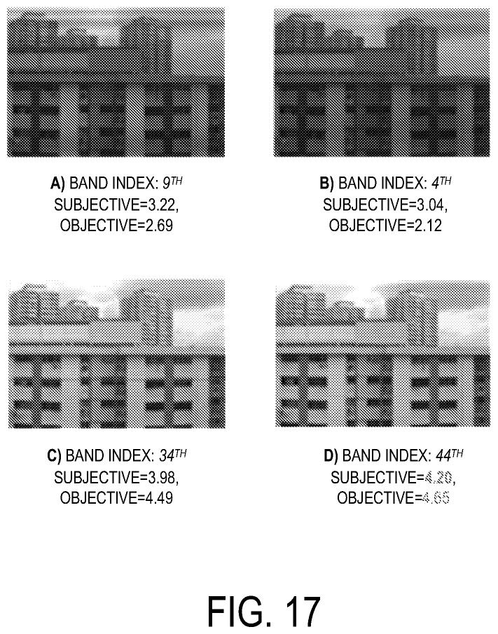

FIG. 17 illustrates existing BS methods compared with the proposed BS method. FVG (discussed in X. Geng, et al., “A fast volume-gradient-based band selection method for hyperspectral image,” in IEEE Transactions on Geoscience and Remote Sensing, vol. 52, no. 11, pp. 7111-7119, 2014) and E-FDPC (discussed in Q. Wang, F. Zhang, and X. Li, “Optimal clustering framework for hyperspectral band selection,” in IEEE Transactions on Geoscience and Remote Sensing, vol. 56, no. 10, pp. 5910-5922, October 2018) choose the best band from the range of short wavelengths. The selected images tend to be dark and low-contrast. MVPCA (discussed in Q. Wang, F. Zhang, and X. Li, “Optimal clustering framework for hyperspectral band selection,” in IEEE Transactions on Geoscience and Remote Sensing, vol. 56, no. 10, pp. 5910-5922, October 2018) presents a better image, but it introduces some gradient artifacts. The proposed BS method achieves the selection of the best band, which contains complete information. Both MVPCA and the proposed method select the band from the range of long wavelengths, introducing a bright image.

To confirm the proposed BS method that the selection relates to the human perceptual decision, almost a hundred images were tested by 55 examiners. The examiners do not have any visual problems, including colorblindness. The subjective perception scores assigned by the human examiners are categorized into five classes: 1=bad, 2=poor, 3=fair, 4=good, and 5=excellent. The total scores are presented by Mean Opinion Score (MOS) (discussed in Methods for Subjective Determination of Transmission Quality, ITU-T Recommendation, pp. 800, 1996).

FIG. 17 shows a comparison of band selection techniques. FIG. 17(a) shows the image from the 9^{th} band of a hyperspectral cube, which is chosen by fast volume-gradient (FVG). FIG. 17(b) shows the image from the 4^{th} band of the hyperspectral cube, which is chosen by split-and-merge and an enhanced fast density-peak-based clustering (E-FDPC). FIG. 17(c) shows the image from the 34^{th} band of the hyperspectral cube, which is chosen by a maximum-variance principal component analysis (MVPCA). FIG. 17(d) shows the image from the 44^{th} band, which is chosen by a subjective evaluation and the proposed band selection technique. FIG. 17 shows that band selected by the proposed selection methods has the highest subject and objective perception scores. Multi-Band Selection: Three primaries (RGB) colors are conventionally used for presenting a color image. To generate a visualized image for a trichromatic display, three most informative bands must be selected from different wavelengths. The selection of the three most informative bands among several hundred spectrum bands related to a human perceptual decision is challenging. The proposed BS method obtains the three best bands by taking a few bands around their local maximum bands. Table C.II below lists the respective band selection measure that

Tables C.II and C.III below illustrate how the proposed methods for band selection compare to conventional methods for band selection. Tables C.II and C.III show the results of a test in which the same hyperspectral cube was processed using different BS techniques. Table C.II shows the band selection techniques and respective band selection measures used. Table C.III shows the values of the three highest band selection measures for different ones of the band selection measures, as well as the respective bands to which the highest band selection measures correspond. The bands associated with the three highest BS measure values for each BS method can be reconstructed into a true-color image because the three best bands that are yielded by the proposed methods range sufficiently close to 625-740 nm, 500-565 nm, and 450-485 nm, respectively.

TABLE C.II
Hyperspectral Band Selection Measures

| | |
|---|---|
| Method | Band Selection Measure |
| FVG | High-Dimensional Volume |
| Split & | Correlation |
| Merge | |
| E-FDPC | Enhanced Fast Density-Peak-Based |
| | Clustering |
| MVPCA | Maximum-Variance Principal Component |
| | Analysis |
| Subjective | Mean Opinion Score |
| Proposed | Block-Based Band Selection |

TABLE C.III
Hyperspectral Band Selection and Evaluations

| Method | First Band | Second Band | Third Band |
|---|---|---|---|
| FVG | 9^{th}: 72.81 | 44^{th}: −0.80 | 40^{th}: −6.70 |
| Split & | 49^{th}: 1.00 | 33^{rd}: 0.97 | 31^{st}: 0.94 |
| Merge | | | |
| E-FDPC | 4^{th}: 1.00 | 48^{th}: 0.35 | 34^{th}: 0.11 |
| MVPCA | 34^{th}: 1.57 | 11^{th}: 1.06 | 28^{th}: 0.97 |
| MOS | 44^{th}: 4.20 | 40^{th}: 4.20 | 39^{th}: 4.20 |
| Proposed | 35^{th}: 4.49 | 45^{th}: 4.27 | 13^{th}: 2.79 |
| Methods | | | |

C.4 Effectiveness of the Proposed Methods. The multi-band selection could be applied for the composition of an HSI-to-RGB presentation. It could enhance human visualization passed through a trichromatic display. Su et al. reviewed hyperspectral image visualization using band selection (see H. Su, et al., “Hyperspectral Image Visualization Using Band Selection,” in IEEE Journal of Selected Topics in Applied Earth Observations and Remote Sensing, vol. 7, no. 6, pp. 2647-2658, 2014). The true-color composition is the method to choose the three bands from different visible wavelengths (discussed in P. Tang, and C. Tai, “Nano-colorimetrically determined refractive index variation with ultra-high chromatic resolution,” Optics Express, vol. 27, no. 8, pp. 11709-11720, 2019). The infrared color composition is similar to true-color production, but one of them is from invisible wavelengths. Those compositions may present insufficient quality information since those selected bands fall in the three specific wavelengths. Therefore, the multi-band selection is applied to select the three best informative bands without categorizing the selected bands into three spectral ranges, after which the selected bands are mapped into RGB color space by using color mapping functions.

The definition of measures: The discussion of Tables C.IV and C.V, which follows, uses seven different measures categorized into two classes: original image-dependent measures, and original image-independent measures.

The original image-dependent measures refer to the original color image to evaluate the performance of color visualization. Structural Similarity Index Metric (SSIM) (discussed in W. Zhou, et al., “Image Quality Assessment: From Error Visibility to Structural Similarity.” IEEE Transactions on Image Processing, vol. 13, no. 4, pp. 600-612, April 2004) is a perceptual metric that expresses image quality degradation. It cannot judge which of two images is better, but it can infer from high numbers close to original structure details. Cross-Correlation (CC) (discussed in J. Yang, et al., “SAR Ground Moving Target Imaging with Adjacent Cross Correlation function,” 6th Asia-Pacific Conference on Synthetic Aperture Radar (APSAR), Xiamen, China, pp. 1-5, 2019) enables estimating of two images, which mostly resemble each other in the same location. It is very sensitive if the structure details are close to the original information, but it is slightly moved to another position. Color Quality Enhancement (COE) (discussed in Y. Fu, “Color image quality measures and retrieval,” PhD thesis, Department of Computer Science, New Jersey Institute of Technology, January 2006) measure uses to combine chrominance information with the criteria SSIM, CC, and Color/Cube Root Mean Enhancement (CRME) (discussed in K. Panetta, C. Gao, and S. Agaian, “No reference color image contrast and quality measures,” in IEEE Transactions on Consumer Electronics, vol. 59, no. 3, pp. 643-651, August 2013)

The original image-independent measures do not require original information. It judges which one generates better performance. CRME (discussed in K. Panetta, C. Gao, and S. Agaian, “No reference color image contrast and quality measures,” in IEEE Transactions on Consumer Electronics, vol. 59, no. 3, pp. 643-651, August 2013) evaluates the color cube center's relative difference and all the neighbors in small blocks. This measure relates to human perception. Colorfulness (CF) (discussed in K. Panetta, C. Gao, and S. Agaian, “No reference color image contrast and quality measures,” in IEEE Transactions on Consumer Electronics, vol. 59, no. 3, pp. 643-651, August 2013) is the property of a visual perception according to an object's perceived colors. Improved Colorfulness (ICF) 37 (discussed in C. Gao, K. Panetta, and S. Agaian, “No reference color image quality measures,” 2013 IEEE International Conference on Cybernetics (CYBCO), Lausanne, 2013, pp. 243-248) is formulated as the ratio of variance to average chrominance in a logarithmic term. It is more relative to human perception than the classical CF measure. Mean Opinion Score (MOS) is a subjective evaluation by human evaluation.

An analysis is now provided of the influence of different colormaps. Tables C.IV and C.V illustrate the result of an experiment in which the performance of different colormaps is compared. This experiment is performed using an image data set. The results of the experiment are separated into two categories: i) results without an original color image; and ii) results with an original color image. For the comparison without an original color image, detail availability is in different hyperspectral bands. The comparison reveals the performance of excellent visualization. Another comparison includes an original color image, and the comparison shows the preservation performance in terms of the color contrast with structural details. Table C.V presents the visualization performance with an original image. The proposed visualization method outperforms other existing methods. Also, the proposed method can preserve original structural details while providing high color contrast. The main reason is that the proposed visualization fully exploits an HSI cube by selecting several highest informative bands to generate color components. Table C.IV presents the visualization performance without an original image. The proposed rainbow-based visualization obtains better visualization performance in terms of colorfulness. The main reason is that the proposed rainbow-based colormap provides an even transition range of primary colors. Tables C.VI and V illustrate that the proposed methods produce better or comparable quality than several well-known and state-of-the-art visualization techniques. Moreover, they can enhance the displayed image brightness, information content (texture detail information), and color vividness. The presented framework can be effectively applied to various images and video sequences, including optimal images, thermal images, and medical images.

TABLE C.IV

| Method | SSIM | CC | CRME | COE |
|---|---|---|---|---|
| CMF | 0.4133 | 1.8263 | 8.6169 | 10.8565 |
| DHIV | 0.0545 | 1.4513 | 8.0550 | 9.5608 |
| MPCNN | 0.6700 | 1.7990 | 8.3778 | 10.8467 |
| PCA | 0.3385 | 1.2755 | 8.5821 | 10.1961 |
| PCA-HE | 0.0527 | 1.0580 | 8.5077 | 9.6183 |
| True Color | 0.7487 | 1.9678 | 8.3221 | 11.0386 |
| VisMap (w/o | 0.8725 | 1.8825 | 8.5548 | 11.3762 |
| original image) | | | | |

TABLE C.V

| Method | CF | ICF | CRME | MOS |
|---|---|---|---|---|
| CMF | 25.8137 | 0.0949 | 8.6169 | 3.1429 |
| DHIV | 40.7402 | 0.1082 | 8.0550 | 3.3571 |
| MPCNN | 47.1634 | 0.1529 | 8.3778 | 3.7857 |
| PCA | 23.0813 | 0.1619 | 8.5821 | 1.7143 |
| PCA-HE | 139.1174 | 0.3259 | 8.5077 | 1.5714 |
| True Color | 36.3922 | 0.1291 | 8.3221 | 3.8571 |
| VisMap | 79.1751 | 0.1677 | 8.5548 | 4.1429 |
| RainbowMap | 219.3545 | 0.3340 | 8.0767 | 1.5000 |
| TopoMap | 130.1444 | 0.2575 | 7.8232 | 1.5714 |

### Part D—Multimodal Bacteria Species Identification

D.1 Introduction. Fast and reliable pathogen identification is an important task for biomedical image analysis systems. It is a challenging problem due to the similar appearance of different bacteria species and the limited size of available datasets. Due to the nature of the task relatively complex approaches combining transfer learning and hand-crafted features were proposed in the literature. Most of the previous works on the topic are focused on the classification of a limited number of species of different genera, often with the use of additional information such as hyperspectral microscopy images.

The instant part of the disclosure addresses the problem of bacteria genera and species classification. The instant part of the disclosure proposes a system and a training algorithm that takes advantage of polynomial decompositions namely the Chebyshev transform for efficient training on a small dataset. The training procedure takes into account only parts of the images that contain bacteria cells and deals with the imbalance of the dataset. Specifically, the instant part introduces a novel Chebyshev polynomial transform-based layer to replace the convolutional layer in a CNN architecture to improve classification performance when training on datasets of limited size as is usually the case for biomedical applications.

In one aspect, the proposed system adds one more tool in the toolbox of deep learning for computer vision, especially in biomedical applications. In general, spectral information could be reconstructed only with a limited number of components. For the method based on principal component analysis, it is enough to use 5 components to obtain a reconstruction of reasonable accuracy. For more sophisticated non-linear techniques it is enough to use just 3 color components. It is possible because commercially available sensors “mimic” human color perception and use complex camera spectral sensitivity functions that are partially overlapped between red, green, and blue channels.

The proposed system may use any suitable method for spectral reconstruction. In one implementation, the proposed system may use an adaptive weighted attention network (AWAN) for spectral reconstruction, which is introduced in Kang, Rui, et al. “Single-cell classification of foodborne pathogens using hyperspectral microscope imaging coupled with deep learning frameworks.” Sensors and Actuators B: Chemical 309 (2020): 127789. The network may be trained on the NTIRE 2020 Challenge dataset and shows reasonable results of reconstruction even for not natural images. In training the network, spectral information from images in the HAM10000 dataset. (See Tschandl, Philipp, Cliff Rosendahl, and Harald Kittler. “The HAM10000 dataset, a large collection of multi-source dermatoscopic images of common pigmented skin lesions.” Scientific data 5 (2018): 180161.)

In some implementations, the proposed system may include a recurrent neural network (RNN). The RNN may exploit a recurrent procedure to characterize spectral correlation and band-to-band variability, where the network parameters are determined by training with available samples. The RNN may use a purpose-specific activation function and modified gated recurrent unit (GRU) to perform multiclass classification for hyperspectral imagery. The activation function may include the parametric rectified tanh (PRetanh) function, which generalizes the rectified unit for the RNN and then modifies the proposed activations of GRUs with it.

In some implementations, the proposed system may represent and process the pixels of hyperspectral images via a sequential perspective instead of taking them as feature vectors to capture the intrinsic sequence-based data structure of hyperspectral pixels. This enables the proposed system to take full advantage of the sequential property of hyperspectral data, e.g., spectral correlation and band-to-band variability.

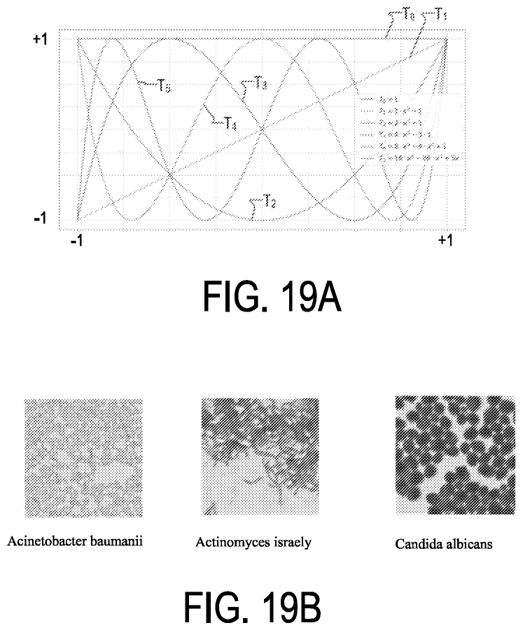

D.2 Proposed Neural Network. According to aspects of the disclosure, a convolutional neural network is provided that relies on training in the domain of a polynomial transform instead of learned convolutional filters. The neural network may include two main components: a polynomial transform layer and a windowing polynomial transforms such as Chebyshev transform produce transform coefficients useful for solving different image processing and image understanding tasks. An example of images that may be classified with the proposed neural network is shown in FIG. 19B.

D.2.a Chebyshev Polynomials and Chebyshev transform. The main advantage of the discrete Chebyshev transform (DChT) is from approximation properties of Chebychev polynomials. This means that for polynomials with a finite number of terms, the expansion in Chebyshev polynomials has a smaller absolute error. The guiding principle of the Chebyshev expansion is to minimize the maximum error. Approximation based on ideological features of minimum square-law errors (while some significant outliers are allowed), Chebyshev's—errors of the module and all its intervals are the same.

There are two standard ways to define a DChT: in the roots of the polynomial or in extrema of the function. The present disclosure uses the first definition. Considering the interval I=[−1,1], the function Tₖ(x)=cos(k arccos x) is defined for all k∈N₀ and all x∈I. Applying the substitution x=cos t, t∈[0, π], it can be observed that Tₖ(cos t)=cos(kt), k∈N₀, for all t∈[0, π] and hence for all t∈R.

Polynomials are defined by the recursion formula Tₖ₊₁(x)=2xT^{k}(x)−Tₖ₋₁(x), k∈N, with initial polynomials T₀(x)=1 and T₁(x)=x. Thus Tₖ is an algebraic polynomial of degree k with leading coefficient 2^{k-1}. Clearly, the polynomials Tₖ can be extended to R such that the recursion formula holds for all x∈R. The polynomial Tₖ: R→R of degree k∈N₀ is called the k-th Chebychev polynomial of the first kind. Polynomials T₀ . . . T₅ are shown in FIG. 19A.

Chebyshev coefficients can be used to efficiently represent images. The sparse representation is also appropriate for storage and transmission. Besides an efficient representation Chebyshev polynomial coefficients can be used for direct image analysis and processing, rather than using image samples. This allows the performance of analytic computations of derivatives and integrals of functions without the need for their discrete approximations, which in turn leads to continuous forms of standard image analysis algorithms.

In some implementations, a 3×3 discrete Chebyshev transform may be used to obtain Chebyshev coefficients. An input feature map is divided into blocks, and each block is represented by its own set of Chebyshev polynomial coefficients. The two-dimensional approximation function of an image block is defined as:

$$\hat{f} ( x , y ) = {\sum }_{i} {\sum }_{j} {s}_{i , j} {T}_{i} ( x ) {T}_{j} ( y ) ,$$

where Tᵢ is the one-dimensional Chebyshev polynomial of degree i, and s_{i,j} is a coefficient standing next to two Chebyshev polynomials of degree i and j, respectively. Chebyshev polynomials are defined on argument interval [−1,1] and their local extrema tend to either 1 or −1. This makes them practical for applications in signal and image approximations.

The discrete Chebyshev transform of u(x) at the points xₙ is given by:

$${a}_{m} = \frac{{p}_{m}}{N} {\sum }_{n}^{N 1} u ( {x}_{n} ) {T}_{m} ( {x}_{n} ) ,$$

where:

$${x}_{n} = - cos ( \frac{π}{N} ( n + \frac{1}{2} ) ) , {a}_{m} = \frac{{p}_{m}}{N} {\sum }_{n = 0}^{N 1} u ( {x}_{n} ) cos ( {mcos}^{- 1} ( {x}_{n} ) ) ,$$

and pₘ=1⇔m=0 and pₘ=2 otherwise. Or, using the definition of xₙ, for the one-dimensional case:

$${a}_{m} = \frac{{p}_{m}}{N} {\sum }_{n = 0}^{N - 1} u ( {x}_{n} ) cos ( \frac{m π}{N} ( N + n + \frac{1}{2} ) ) ,$$

$${a}_{m} = \frac{{p}_{m}}{N} {\sum }_{n = 0}^{N - 1} u ( {x}_{n} ) {( - 1 )}^{m} cos ( \frac{m π}{N} ( n + \frac{1}{2} ) ) .$$

In a convolutional network, a polynomial block may be used to replace a conventional convolutional operation, which relies on processing the data in two stages. Firstly, the input features may undergo polynomial decomposition by a transformation method. Conceptually, various transformation methods can be used e.g. wavelets, derivatives of Gaussians, etc. However, in the Chebyshev network that is introduced in this section, a window-based DChT, is used In the second stage (i.e., the stage following the input layer) the transformed signals are combined by learned weights. The fundamental difference from standard convolutional network is that the optimization algorithm is not searching for the filter parameters that extract spatial correlation, rather the optimization algorithm learns the relative importance of preset feature extractors (DChT filters) at multiple layers.

D.2.b Two-Dimensional Chebyshevian Neural Network. A CNN is usually composed of alternate convolutional and max-polling layers (denoted as C layers and P layers) to extract hierarchical features from the original inputs (receptive field), subsequently with several fully connected layers (denoted by FC layers) followed to do classification. Considering a CNN with L layers, the output state of l-th layer is denoted as Hₗ, where l∈{1, . . . , L}, additionally using H⁰ to denote the input data. There are two parts of trainable parameters in each layer, i.e., the weight matrix W that connects the l-th layer and its previous layer with state H^{l-1}, and the bias vector bₗ.

In general, the input data are usually connected to a C layer. For a C layer, a 2-D convolution operation is performed first with convolutional kernels Wₗ. Then, the bias term bₗ is added to the resultant feature maps, in which a pointwise nonlinear activation operation g(⋅) is typically performed subsequently. Finally, a max-pooling layer is usually followed to select the dominant features over nonoverlapping square windows per feature map. The whole process can be formulated as H^{l}=pool(g(H^{l-1}*Wₗ+bₗ)), where * denotes the convolution operation and pool denotes the max-pooling operation. Several C layers and P layers can be stacked one by one to form the hierarchical feature extraction architecture. Then, the resultant features are further combined into 1-D feature vectors by the FC layer. An FC layer first processes its inputs with nonlinear transformation by weight Wₗ and bias bₗ, followed by the pointwise nonlinear activation of: H^{l}=g(H^{l-1}*Wₗ+bₗ). The present disclosure is not limited to using any specific type of activation function. However, in the present example, the relu activation function is used for its high capability and efficiency. The relu activation function can be defined as g(x)=max(0, x) The last classification layer may be a softmax layer, with the amount of neurons equaling the number of classes to be classified. In some implementations, a logistic regression layer with one neuron may be used to do binary classification, which is similar to an FC layer, in which case the activation value would represent the probability of the input belonging to the positive class. The Chebyshev neural network, and its various implementations that are introduced throughout the disclosure, replaces the convolutional operations in the so-called C-layers with discrete Chebyshev transformations. Otherwise, the Chebyshev neural network may have any suitable topology and/or configuration that is used by convolutional neural networks that are known in the art.

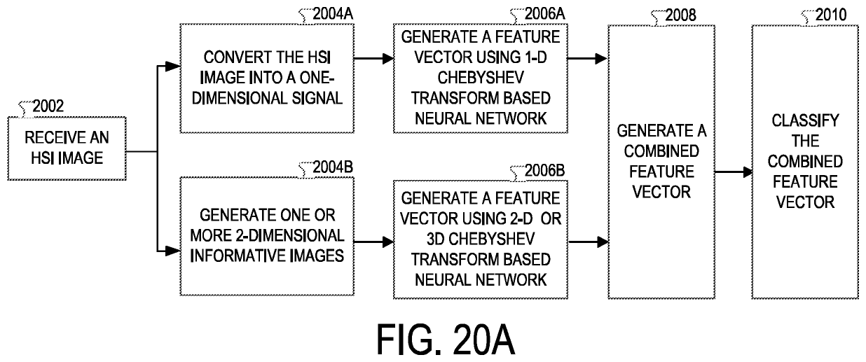

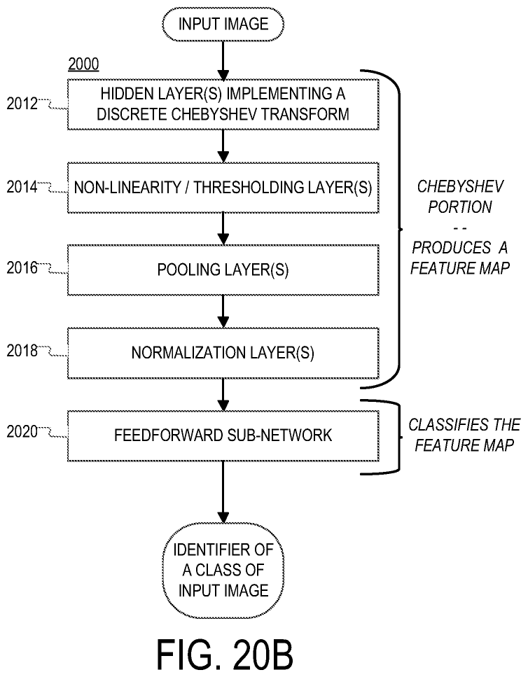

FIG. 20B shows an example of a Chebyshev neural network 2000. The neural network 2000 may include layers 2012-2020. Layer 2012 may include one or more hidden layers that implement a discrete Chebyshev transform. The discrete Chebyshev transform may be a one-dimensional discrete Chebyshev transform, a two-dimensional discrete Chebyshev transform, or a three-dimensional discrete Chebyshev transform. In some implementations, each neuron in the layer 2021 may implement a respective Chebyshev polynomial filter. Examples of 3×3 Chebyshev polynomial filters which can be implemented by any of the neurons is discussed in Z Xu, Y Jiang, Y Wang, Y Zhou, W Li, Q Liao, Local polynomial contrast binary patterns for face recognition, Neurocomputing 355, 1-12, 2019. Each of these filters may receive as input a respective 3×3 segment of the image (or a 3×3 array that is generated based on the image). In some respects, the layer 2012 may perform feature extraction. Additionally or alternatively, in some implementations, the layer 2012 may implement more than one Chebishev transformation. For example, as discussed with respect to FIG. 20A, the layer 2012 may implement a 1D discrete Chebyshev transform and a 2D discrete Chebyshev transform.

Layer 2014 may include one or more non-linearity/threshold layers. Specifically, the layer 2014 may include one or more activation layers. Each of the neurons in the layer 2014 may evaluate the ReLU function and/or any other suitable type of activation function. Layer 2016 may include one or more pooling layer(s). Each of the pooling layers may implement a typical downsampling operation. Layer 2018 may include one or more normalization layers, and layer 2020 may include a feedforward sub-network. The layer 2020 may include a plurality of fully-connected layer, whose common output represents confidence in classification. The normalization layer may convert the actual range of values produced by the preceding layers into a standard range of values. Layers 2012-2018 may be configured to produce a feature map and layer 2020 may be configured to classify the feature map. The feature map may include one or more image features. In other words, the layers 2012-2018 may be configured to perform feature extraction. In addition, the layer 2012-2018 may implement the polynomial block which is discussed above. The feedforward sub-network that is implemented by the layer 2020 may include any suitable set of neural network layers that is customarily used to classify the output of the convolutional layer(s) of a convolution neural network. Although not shown in FIG. 20B, the network 2000 may include one or more additional layers, such as an input layer and an output layer. Furthermore, in some implementations, one roOmroe of layers 2014-2020 may be omitted.

D.2.c One-Dimensional Chebyshev Network. An example is now provided of a one-dimensional convolutional neural network that is based on a Chebishev polynomial. The neural network uses weights {W₁, . . . , W_{L}} and the biases {b₁, . . . , b_{L}}, which are iteratively and jointly optimized through maximization of the classification accuracy over a training set. The network may be implemented using the following Python code.

```
def chebychev_fb(n=7):
  C = np.zeros(shape=(n, n), dtype=np.float32)
  for k in range(n):
        for m in range(n):
          if m == 0:
            pm = 1
          else:
            pm = 2
          C[m, k] = pm*math.pow(−
    1, m)*math.cos((math.pi*m/n)*(k+0.5)) / n
      return tf.convert_to_tensor(C[:, np.newaxis, :], dtype
    =tf.float32)
    def make_model(size, conv_num, dense, num_classes=33):
      mlp = tf.keras.models.Sequential( )
      mlp.add(tf.keras.layers.Input(shape=(31,1)))
      mlp.add(Harm1D(conv_num, size))
      mlp.add(tf.keras.layers.Activation(‘relu’))
      mlp.add(tf.keras.layers.Dropout(0.3))
      mlp.add(tf.keras.layers.BatchNormalization( ))
      mlp.add(tf.keras.layers.MaxPooling1D(pool_size=2))
      mlp.add(tf.keras.layers.Flatten( ))
      mlp.add(tf.keras.layers.Dense(dense,activation=‘relu’)
    )
      mlp.add(tf.keras.layers.Dropout(0.3))
      mlp.add(tf.keras.layers.Dense(num_classes,activation=‘
    softmax’))
      opt = tf.keras.optimizers.Adam(learning_rate=0.001)
      mlp.compile(optimizer=opt, loss=‘categorical_crossentr
    opy’, metrics=[‘accuracy’])
      return mlp
```

D.2.d Combined 1D/2D Network and Training Settings. A CNN-based for remote sensing imagery spatial feature extraction is now described in further detail. For the input layer, image regions can be extracted of fixed size centered on the ground-truth pixels to form the training samples. Suppose that there are M training samples. Suppose that there are M training samples (patches) Sᵢ, i∈(1, . . . , M) that are randomly chosen from the original image, and tᵢ represents the corresponding label of patch Sᵢ. Training a CNN f(W, b|S) with L layers amounts to learning the filters W and the bias parameter b. Then, based on the initialized CNN, the predicted labels of the last layers are y: yᵢ=W^{L}H^{L-1}+b^{L}, i∈{1,2, . . . , M} where Here, yᵢ is the predicted labels based on L-th layer CNN in response to i-th input training sample. Based on the predicted labels, the squared-error loss function L can be written as:

$$min L = \frac{1}{2} {\sum }_{{i = 1}^{}}^{M} {‖ {t}_{i} - {y}_{i} ‖}_{2}^{2} .$$

To minimize the loss function, the backward propagation algorithm may be used to optimize the parameters W and b. The backward propagation algorithm may propagate the predict error L from the last layer to the first layers and modifies the parameter values according to the propagated error at each layer. Commonly, stochastic gradient descent (SGD) algorithm is applied to achieve this goal. In SGD, the derivative of parameters of W and b can be described as

$$Δ {k}^{l} = ( \frac{\partial L}{\partial {W}^{l}} )$$

$$and$$

$$Δ {b}^{l} = ( \frac{\partial L}{\partial {b}^{l}} ) .$$

Based on the gradient of parameter, the loss function can be optimized. Once the loss function convergence is achieved, the optimal parameters W and b of each layer can be determined. For an unlabeled image sample S_{unknown} deep spatial feature O an be extracted by using the pretrained CNN framework.

D.2.d. Training Algorithm. A description is now provided of an algorithm for training the 1D/2D Chebyshev transform-based neural networks, examples of which are provided above. The algorithm updates parameters wᵢⱼ^{l} between transformed feature map indexed by i and output map indexed by j of layer l in the Mini-batch Gradient Descent framework

The input to the algorithm may include input feature maps of oᵢᵢ^{l-1} for each training sample (computed for the previous layer, o^{l-1} is the input image when l=1), corresponding ground-truth labels {y₁,y₂, . . . , y_{K}}, the basis functions {ϕ₁,ϕ₂, . . . , ϕ_{M}}, previous parameter set αᵢⱼ^{l}, and current parameter level λ After the input is received, the algorithm computes the Chebyshev transform {τ₁, τ₂, . . . , τ_{M}} of {oᵢ^{l-1}} with respect to the basis functions. Next, the algorithm obtains the output map. Next, the algorithm computers computes δⱼₙ^{l} for each output neuron n of the output map oⱼ^{l}. Next, the algorithm computes the derivative ψ′(tⱼₙ^{l}) of the activation function. Next, the algorithm computes the gradient

$$\frac{\partial E}{\partial {w}_{ij}^{l}}$$

with respect to the weights wᵢⱼ^{l} for the parameter level λ Next the algorithm updates the parameter wᵢⱼ^{l}. And finally, the algorithm might output the value of wᵢⱼ^{l}, and/or the output feature maps oⱼ^{l}.

An example of one possible usage of the proposed neural network for the purposes of image recognition is shown in FIG. 20A. At step 2002 an input image is received. According to the present example, the input image is a hyperspectral image of bacteria. At step 2004A, the hyperspectral image is converted to a 1-D signal (or a single-channel image). Converting the hyperspectral image to a single-channel image may include calculating the average of (or otherwise combining) the bands in the input image. For example, each pixel N in the single-channel image may be calculated by taking the average of the values of pixel N in each of the bands of the input image, where N>0. At step 2006A, a feature vector is generated using the 1-D signal (created at step 2004A). The feature vector may be calculated by using a 1D Chebyshev transform based neural network. Specifically, the feature vector may be calculated by executing, based on the 1D signal, a layer 2012 (shown in FIG. 20B) of a Chebyshev transform based neural network. At step 2004B, one or more 2D informative images are generated. Each of the 2D informative images may be generated by extracting two channels from the input image (received at step 2002). At step 2006B, a feature vector is generated by using a 2D or 3D Chebyshev based transform neural network. Specifically, the feature vector may be calculated by executing, based on the 2D informative images, the layer 2012 (shown in FIG. 20B) of the Chebyshev transform based neural network. At step 2008, the feature vectors (generated at step 2006A-B) are combined to produce a combined feature vector. At step 2010, the combined feature vector is classified. For example, the classification may be performed by using a feedforward network. Specifically, the classification may be performed by using layer 2020 of the network that is shown in FIG. 20B.

D.3.d Dataset normalization. Data that is classified with the disclosed networks and/or data that is used to train the disclosed neural networks may be preprocessed. A min-max normalization defined in Eq. (D1) can be used for preprocessing of intensity image dataset, which transforms pixel intensity values from minimum (0) to maximum). For spectral profile dataset, standard normal variate (SNV) as defined in Eq. (D2) can be employed for data preprocessing.

$${X}_{nor} = \frac{X - {X}_{min}}{{X}_{max} - {X}_{min}} \qquad ( D 1 )$$

$${\hat{x}}_{k} = \frac{{x}_{k} - {X}_{mean}}{{X}_{std}} \qquad ( D 2 )$$

In Eq. (D1), X denotes image pixel intensity matrix, Xₘᵢₙ is minimum value, Xₘₐₓ is maximum value, and Xₙₒᵣ is normalized value. In Eq. (D2) xₖ is spectra of k^{th} sample, Xₘₑₐₙ is mean value, X_{std} is standard deviation, and \hat{x}ₖ is transformed result.

D.3.b Training Patch Preparation. All images in the training dataset are split into non-overlapping blocks of the size 224×224. The blocks with less than 6% of area dedicated to the cells are removed. To determine the overall area of the bacteria cells in the block, the Otsu's or other segmentation method may be used for example in T. Trongtirakul, S. Agaian “Unsupervised and Optimized Thermal Image Quality Enhancement and Visual Surveillance Application,” Signal Processing: Image Communication, Apr. 13, 2022; or S. Benbelkacem, et al., COVI3D: Automatic COVID-19 CT Image-Based Classification and Visualization Platform Utilizing Virtual and Augmented Reality Technologies. MDPI Diagnostics, 12, 649. 2022, https://doi.org/10.3390/diagnostics12030649; A.Oulefk, S. Agaian, T. Trongtirakul, A. Laouar, Automatic COVID-19 Lung Infected Region Segmentation and Measurement Using CT-Scans Images, Elsevier Pattern Recognition, Vol. 114, 2 Jun. 2021, 107747.

D.3.d Hyperspectral Reconstruction. Due to the lack of the publicly available hyperspectral datasets, a spectral reconstruction method may be used to produce images for various wavelengths in the range 400 . . . 700 nm. In the present example, an adaptive weighted attention network with camera spectral sensitivity prior for spectral reconstruction from RGB Images is used to perform hyperspectral reconstruction (e.g., see Li, Jiaojiao, et al. “Adaptive weighted attention network with camera spectral sensitivity prior for spectral reconstruction from rgb images.” Proceedings of the IEEE/CVF Conference on Computer Vision and Pattern Recognition Workshops. 2020.).

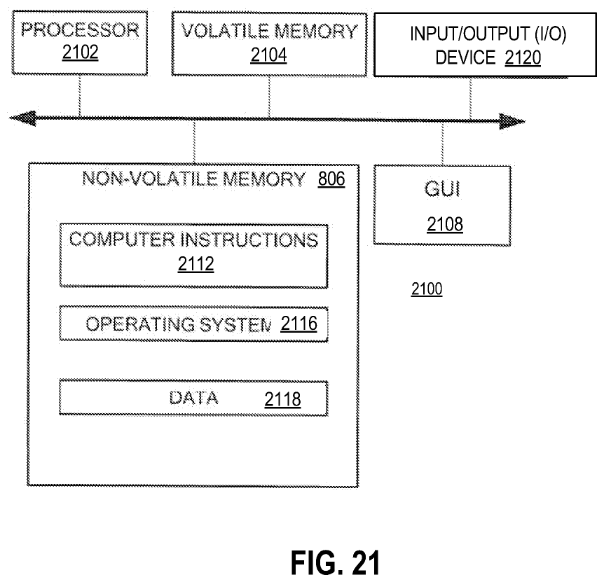

Referring to FIG. 21, computing device 2100 may include processor 2102, volatile memory 2104 (e.g., RAM), non-volatile memory 2106 (e.g., a hard disk drive, a solid-state drive such as a flash drive, a hybrid magnetic and solid-state drive, etc.), graphical user interface (GUI) 2108 (e.g., a touchscreen, a display, and so forth) and input/output (I/O) device 2120 (e.g., a mouse, a keyboard, etc.). Non-volatile memory 2106 stores computer instructions 2112, an operating system 2116 and data 2118 such that, for example, the computer instructions 2112 are executed by the processor 2102 out of volatile memory 2104. Program code may be applied to data entered using an input device of GUI 2108 or received from I/O device 2120. In some implementations, any of the processes described throughout the disclosure can be executed by computing device 2100.

Processor 2102 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard-coded into the electronic circuit or soft coded by way of instructions held in a memory device. A “processor” may perform the function, operation, or sequence of operations using digital values or using analog signals. In some embodiments, the “processor” can be embodied in an application-specific integrated circuit (ASIC). In some embodiments, the “processor” may be embodied in a microprocessor with associated program memory. In some embodiments, the “processor” may be embodied in a discrete electronic circuit. The “processor” may be analog, digital or mixed-signal. In some embodiments, the “processor” may be one or more physical processors or one or more “virtual” (e.g., remotely located or “cloud”) processors.

FIGS. 1-22 are provided as an example only. At least some of the steps discussed with respect to FIGS. 1-22 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs.

The terms “HSI cube” and “hyperspectral image” are used interchangeably throughout the disclosure. The terms “channel of an image”, “band of an image” or “slice of an image” are also used interchangeably. The term “band of an image” may refer to a numerical array of pixel values that are indicative of the level of light “in a particular frequency/wavelength band”. For ease of description, a 1-channel image would consist of one band (or numerical array of pixels), a 2-channel image would consist of two bands (or numerical arrays of pixels), a 3-channel image would consist of three bands (or numerical arrays of pixels), and a hyperspectral image would include a large number of channels (or numerical arrays). In practice, however, the numerical arrays of pixels in a multi-channel image may be encoded into a single numerical array of values, where each pixel value encodes multiple channel levels. The phrase “replacing the X-channel in image A with the Y-channel in image B” refers to the notion of replacing a channel from one color space with another channel from a different color space. The replacement may be performed by: removing a first numerical array corresponding to channel X from a data structure that represents image A, and inserting a second numerical array corresponding to channel Y in the numerical array. In some implementations, the replacement may entail designating the second numerical array as encoding channel X.

Consider an RGB-to-HSV transformation T(r, g, b), where r, g, b are the respective red, green, and blue channels of an RGB image. Consider also a set of bands b1, b2, and b3 that are selected from a hyperspectral image. The “phrase performing RGB-to-HSV conversion on the selected bands” may refer to evaluating T(b1, b2, b3). The phrase generating an “RGB image based on the selected bands” may refer to designating one of the bands as a red channel, designating another of the bands as a green channel, and designating the other of the bands as a blue channel, which designations are made for the purposes of evaluating the transform T. Although it could, the phrase “generating an RGB image from a set of selected bands” does not necessarily imply the creation of a specific file (or another data structure) that includes metadata identifying the file (or other data structure) as an RGB image. The term “single-channel image” may refer to a grayscale image or a single band that is extracted from a multi-channel image. The phrase “coloring a single-channel image” may include evaluating the equations that constitute a color map based on the single-channel image to produce the respective channels of a color image.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
receiving a hyperspectral image of a scene;
selecting one or more bands from the hyperspectral image; and
processing the selected bands to produce a color image.

2. The method of claim 1, wherein processing the selected bands to produce a color image includes:
generating an LMS image by performing an RGB-to-LMS conversion on the selected bands;
replacing a V-channel of an HSV image with an enhanced L-channel of the LMS image to produce a resultant HSV image, the HSV image being an image of the same scene as the hyperspectral image; and
performing an HSV-to-RGB conversion on the resultant HSV image to produce the color image.

3. The method of claim 2, wherein replacing the V-channel of the HSV image with the L-channel of the LMS image includes replacing the L-channel with a logarithmic of the L-channel.

4. The method of claim 1, wherein processing the selected bands to produce a color image includes coloring the selected bands by using a fusion color map to produce the color image, the fusion color map being arranged to fuse a plurality of different color models.

5. The method of claim 4, wherein the plurality of different color models includes a jet color model, a rainbow color model, and a sine color model.

6. The method of claim 1, wherein processing the selected bands to produce a color image includes:
generating a grayscale image by performing RGB-to-grayscale conversion on the selected bands; and
coloring the grayscale image by using a fusion color map to produce the color image, the fusion color map being arranged to fuse a plurality of different color models.

7. The method of claim 6, wherein the fusion color map is defined by the equations of:
$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$
$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$
$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$
where β₁ and β₂ represent weights of a color map, Lₘᵢₙ and Lₘₐₓ represent minimum and maximum color luminance levels, respectively, x represents a grayscale luminance level, L represent a total number of luminance levels of the grayscale image, c, αᵣ, α₉ and α_{b} represent a color constant, and xᵢ represents a grayscale luminance threshold, x_{i=1,2, . . . , 7}(iL/8)−1, R_{J}(x) is a function defining a red channel of a first color model, G_{J}(x) is a function defining a green channel of a first color model, B_{J}(x) is a function defining a blue channel of a first color model, R_{P} (x) is a function defining a red channel of a second color model, G_{P}(x) is a function defining a green channel of a second color model, Bₚ(x) is a function defining a blue channel of a second color model, R_{R}(x) is a function defining a red channel of a third color model, G_{R} (x) is a function defining a green channel of a third color model, B_{R} (x) is a function defining a blue channel of a third color model.

8. The method of claim 1, wherein processing the selected bands to produce a color image includes:
generating an LMS image by performing an RGB-to-LMS conversion on the selected bands;
extracting a channel of the LMS image; and
coloring the extracted channel with a color map to produce the color image.

9. The method of claim 1, further comprising:
classifying the color image with a neural network, the neural network including at least one hidden layer that implements at least one of a discrete Chebyshev transform, the discrete Chebyshev transform including one of a one-dimensional Chebyshev transform a two-dimensional Chebyshev transform, and a three-dimensional Chebyshev transform,
wherein the neural network further includes one or more layers that are arranged to form a feedforward sub-network, the feedforward sub-network being arranged to classify a set of features that is produced, at least in part, by the at least one hidden layer, the set of features being produced based on the color image.

10. A method comprising:
receiving a hyperspectral image;
calculating an unsupervised HVS-based selection measure (BBS) that is defined by the equations of:
$$BBS = \frac{0.5681}{N \cdot M} {\sum }_{i = 1}^{N} {\sum }_{j = 1}^{M} Δ D \cdot log ( \frac{Δ D + c}{{[ {I}_{max} ]}_{i , j}^{m , n} + {[ {I}_{min} ]}_{i , j}^{m , n} + c} )$$
$$Δ D = {[ {I}_{max} ]}_{i , j}^{m , n} - {[ {I}_{min} ]}_{i , j}^{m , n} ; Δ D > τ$$
where N and M represent a size of the hyperspectral image in width and height, m and n denote a size of a local block, [Iₘᵢₙ]_{i,j}^{m,n} and [Iₘₐₓ]_{i,j}^{m,n} are a block-based minimum luminance and a block-based maximum luminance, respectively, c is a constant, and r is a threshold value;
generating a band measure histogram;
smoothening the histogram;
selecting a most informative band on the smoothened histogram;
selecting a plurality of bands around the most informative band; and
combining the selected bands to produce a single-channel image.

11. A method comprising:
receiving a hyperspectral image;
calculating an unsupervised HVS-based selection measure (BBS) that is defined by the following equations of:
$${BBS}_{λ} = \frac{0.5681}{N \cdot M} {\sum }_{i = 1}^{N} {BBS}_{i , j , λ}$$
$${BBS}_{i , j , λ} = {\sum }_{j = 1}^{M} ΔD \cdot log ( \frac{Δ D + c}{{[ {I}_{max} ]}_{i , j , λ}^{m , n} + {[ {I}_{min} ]}_{i , j , λ}^{m , n} + c} )$$
$$Δ D = {[ {I}_{max} ]}_{i , j , λ}^{m , n} - {[ {I}_{min} ]}_{i , j , λ}^{m , n} ; Δ D > τ$$
where N and M represent a size of the hyperspectral image in width and height, m and n denote a size of a local block, [Iₘᵢₙ]_{i,j,λ}^{m,n} and [Iₘₐₓ]_{i,j,λ}^{m,n} are a block-based minimum luminance and a block-based maximum luminance, respectively, c is a constant, and τ is a threshold value;
generating a band measure histogram;
smoothening the histogram;
selecting, based on the smoothened histogram, a plurality of bands that correspond to local maxima;
selecting, based on the smoothened histogram, a plurality of additional bands; and
combining the bands that correspond to local maxima and the plurality of additional bands to produce a multiple-band image.

12. A method comprising:
receiving a single-channel image; and
coloring the single-channel image with a fusion color map to produce a color image, the fusion color map being arranged to fuse a plurality of different color models.

13. The method of claim 12, wherein the fusion color map is defined by the equations of:
$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$
$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$
$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$
where β₁ and β₂ represent weights of a color map, Lₘᵢₙ and Lₘₐₓ represent minimum and maximum color luminance levels, respectively, x represents a grayscale luminance level, L represent a total number of luminance levels of the single-channel image, c, αᵣ, α₉ and α_{b} represent a color constant, and xᵢ represents a grayscale luminance threshold, x_{i=1,2, . . . , 7}=(iL/8)−1, R_{J}(x) is a function defining a red channel of a first color model, G_{J}(x) is a function defining a green channel of a first color model, B_{J}(x) is a function defining a blue channel of a first color model, Rₚ(x) is a function defining a red channel of a second color model, G_{P}(x) is a function defining a green channel of a second color model, B_{P}(x) is a function defining a blue channel of a second color model, R_{R}(x) is a function defining a red channel of a third color model, G_{R} (x) is a function defining a green channel of a third color model, B_{R}(x) is a function defining a blue channel of a third color model.

14. The method of claim 12, wherein the single-channel image includes a grayscale image.

15. The method of claim 12, wherein the single-channel image includes one of the channels in a multi-channel image.

16. The method of claim 12, wherein the single-channel image is generated by extracting one or more channels from a hyperspectral image.

17. A method of claim 12, further comprising calculating image dependent-thresholds (x₁, x₂, . . . , xₙ) based on a total count of luminance levels in the single-channel image, wherein the fusion map is based on the image dependent thresholds.

18. A method comprising:
receiving a hyperspectral image; and
classifying the image with at least one neural network that includes at least one hidden layer that is configured to implement a discrete Chebyshev transform.

19. The method of claim 18, wherein the discrete Chebyshev transform includes at least one of a one-dimensional Chebyshev transform, a two-dimensional Chebyshev transform, and a three-dimensional Chebyshev transform.

20. The method of claim 18, wherein the neural network further includes one or more bands/layers that are arranged to form a feedforward sub-network, the feedforward sub-network being arranged to classify a set of features that is produced, at least in part, by the at least one hidden layer, the set of features being produced based on the image.

21. The method of claim 18, wherein classifying the image with at least one neural network includes:
generating a one-dimensional signal based on the hyperspectral image and generating a first set of features based on the one-dimensional signal, the first set of features being generated by using a one-dimensional discrete Chebyshev transform;
generating a two-dimensional image based on the hyperspectral image and generating a second set of features based on the two-dimensional image, the second set of features being generated by using a two-dimensional or three-dimensional discrete Chebyshev transform;
generating a combined set of features based on the first set of features and the second set of features; and
classifying the combined set of features.

22. A system, comprising:
a memory; and
at least one processor operatively coupled to the memory, the at least one processor being configured to perform the operations of:
receiving a hyperspectral image of a scene;
selecting one or more bands from the hyperspectral image; and
processing the selected bands to produce a color image.

23. The system of claim 22, wherein processing the selected bands to produce a color image includes:
generating an LMS image by performing an RGB-to-LMS conversion on the selected bands;
replacing a V-channel of an HSV image with an enhanced L-channel of the LMS image to produce a resultant HSV image, the HSV image being an image of the same scene as the hyperspectral image; and
performing an HSV-to-RGB conversion on the resultant HSV image to produce the color image.

24. The system of claim 23, wherein replacing the V-channel of the HSV image with the L-channel of the LMS image includes replacing the L-channel with a logarithmic of the L-channel.

25. The system of claim 22, wherein processing the selected bands to produce a color image includes coloring the selected bands by using a fusion color map to produce the color image, the fusion color map being arranged to fuse a plurality of different color models.

26. The system of claim 25, wherein the plurality of different color models includes a jet color model, a rainbow color model, and a sine color model.

27. The system of claim 22, wherein processing the selected bands to produce a color image includes:
generating a grayscale image by performing RGB-to-grayscale conversion on the selected bands; and
coloring the grayscale image by using a fusion color map to produce the color image, the fusion color map being arranged to fuse a plurality of different color models.

28. The system of claim 27, wherein the fusion color map is defined by the equations of:
$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$
$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$
$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$
where β₁ and β₂ represent weights of a color map, Lₘᵢₙ and Lₘₐₓ represent minimum and maximum color luminance levels, respectively, x represents a grayscale luminance level, L represent a total number of luminance levels of the grayscale image, c, αᵣ, α₉ and α_{b} represent a color constant, and xᵢ represents a grayscale luminance threshold, x_{i=1, 2, . . . , 7}(iL/8)−1, R_{J}(x) is a function defining a red channel of a first color model, G_{J}(x) is a function defining a green channel of a first color model, B_{J}(x) is a function defining a blue channel of a first color model, R_{P}(x) is a function defining a red channel of a second color model, G_{P}(x) is a function defining a green channel of a second color model, B_{P}(x) is a function defining a blue channel of a second color model, R_{R}(x) is a function defining a red channel of a third color model, G_{R}(x) is a function defining a green channel of a third color model, B_{R}(x) is a function defining a blue channel of a third color model.

29. The system of claim 22, wherein processing the selected bands to produce a color image includes:
generating an LMS image by performing an RGB-to-LMS conversion on the selected bands;
extracting a channel of the LMS image; and
coloring the extracted channel with a color map to produce the color image.

30. The system of claim 22, wherein:
the at least one processor is further configured to perform the operation of classifying the color image with a neural network, the neural network including at least one hidden layer that implements at least one of a discrete Chebyshev transform, the discrete Chebyshev transform including one of a one-dimensional Chebyshev transform a two-dimensional Chebyshev transform, and a three-dimensional Chebyshev transform, and
the neural network further includes one or more layers that are arranged to form a feedforward sub-network, the feedforward sub-network being arranged to classify a set of features that is produced, at least in part, by the at least one hidden layer, the set of features being produced based on the color image.

31. A system comprising:
a memory; and
at least one processor that is operatively coupled to the memory, the at least one processor being configured to perform the operations of:
receiving a hyperspectral image;
calculating an unsupervised HVS-based selection measure (BBS) that is defined by the equations of:
$$BBS = \frac{0.5681}{N \cdot M} {\sum }_{i = 1}^{N} {\sum }_{j = 1}^{M} Δ D \cdot log ( \frac{Δ D + c}{{[ {I}_{max} ]}_{i , j}^{m , n} + {[ {I}_{min} ]}_{i , j}^{m , n} + c} )$$
$$Δ D = {[ {I}_{max} ]}_{i , j}^{m , n} - {[ {I}_{min} ]}_{i , j}^{m , n} ; Δ D > τ$$
where N and M represent a size of the hyperspectral image in width and height, m and n denote a size of a local block, [Iₘᵢₙ]_{i,j}^{m,n} and [Iₘₐₓ]_{i,j}^{m,n} are a block-based minimum luminance and a block-based maximum luminance, respectively, c is a constant, and r is a threshold value;
generating a band measure histogram;
smoothening the histogram;
selecting a most informative band on the smoothened histogram;
selecting a plurality of bands around the most informative band; and
combining the selected bands to produce a single-channel image.

32. A system comprising:
a memory; and
at least one processor that is operatively coupled to the memory, the at least one processor being configured to perform the operations of:
receiving a hyperspectral image;
calculating an unsupervised HVS-based selection measure (BBS) that is defined by the following equations of:
$${BBS}_{λ} = \frac{0.5681}{N \cdot M} {\sum }_{i = 1}^{N} {BBS}_{i , j , λ}$$
$${BBS}_{i , j , λ} = {\sum }_{j = 1}^{M} Δ D \cdot log ( \frac{Δ D + c}{{[ {I}_{max} ]}_{i , j , λ}^{m , n} + {[ {I}_{min} ]}_{i , j , λ}^{m , n} + c} )$$
$$Δ D = {[ {I}_{max} ]}_{i , j , λ}^{m , n} - {[ {I}_{min} ]}_{i , j , λ}^{m , n} ; Δ D > τ$$
where N and M represent a size of the hyperspectral image in width and height, m and n denote a size of a local block, [Iₘᵢₙ]_{i,j,λ}^{m,n} and [Iₘₐₓ]_{i,j,λ}^{m,n} are a block-based minimum luminance and a block-based maximum luminance, respectively, c is a constant, and i is a threshold value;
generating a band measure histogram;
smoothening the histogram;
selecting, based on the smoothened histogram, a plurality of bands that correspond to local maxima;
selecting, based on the smoothened histogram, a plurality of additional bands; and
combining the bands that correspond to local maxima and the plurality of additional bands to produce a multiple-band image.

33. A system comprising:
a memory; and
at least one processor operatively coupled to the memory, the at least one processor being configured to perform the operations of:
receiving a single-channel image; and
coloring the single-channel image with a fusion color map to produce a color image, the fusion color map being arranged to fuse a plurality of different color models.

34. The system of claim 33, wherein the fusion color map being defined by the equations of:
$${R}_{F} ( x ) = {β}_{1} {R}_{J} ( x ) + {β}_{2} {R}_{P} ( x ) + ( 1 - {\sum }_{i} {β}_{i} ) {R}_{R} ( x )$$
$${G}_{F} ( x ) = {β}_{1} {G}_{J} ( x ) + {β}_{2} {G}_{P} ( x ) + ( 1 - {\sum }_{i} {β}_{i} ) {G}_{R} ( x )$$
$${B}_{F} ( x ) = {β}_{1} {B}_{J} ( x ) + {β}_{2} {B}_{P} ( x ) + ( 1 - {\sum }_{i} {β}_{i} ) {B}_{R} ( x )$$
where β₁ and β₂ represent weights of a color map, Lₘᵢₙ an Lₘₐₓ represent minimum and maximum color luminance levels, respectively, x represents a grayscale luminance level, L represent a total number of luminance levels of the single-channel image, c, αᵣ, α₉ and α_{b} represent a color constant, and xᵢ represents a grayscale luminance threshold, x_{i=1,2, . . . , 7}(iL/8)−1, R_{J}(x) is a function defining a red channel of a first color model, G_{J}(x) is a function defining a green channel of a first color model, B_{J}(x) is a function defining a blue channel of a first color model, R_{P}(x) is a function defining a red channel of a second color model, G_{P}(x) is a function defining a green channel of a second color model, B_{P}(x) is a function defining a blue channel of a second color model, R_{R}(x) is a function defining a red channel of a third color model, G_{R} (x) is a function defining a green channel of a third color model, B_{R}(x) is a function defining a blue channel of a third color model.

35. The system of claim 33, wherein the single-channel image includes a grayscale image.

36. The system of claim 33, wherein the single-channel image includes one of the channels in a multi-channel image.

37. The system of claim 33, wherein the single-channel image is generated by extracting one or more channels from a hyperspectral image.

38. The system of claim 33, wherein the at least one processor is further configured to perform the operation of calculating image dependent-thresholds (x₁, x₂, . . . , xₙ) based on a total count of luminance levels in the single-channel image, wherein the fusion map is based on the image dependent thresholds.

39. A system comprising:
a memory; and
at least one processor that is operatively coupled to the memory, the at least one processor being configured to perform the operations of:
receiving a hyperspectral image; and
classifying the image with at least one neural network that includes at least one hidden layer that is configured to implement a discrete Chebyshev transform.

40. The system of claim 39, wherein the discrete Chebyshev transform includes at least one of a one-dimensional Chebyshev transform, a two-dimensional Chebyshev transform, and a three-dimensional Chebyshev transform.

41. The system of claim 39, wherein the neural network further includes one or more bands/layers that are arranged to form a feedforward sub-network, the feedforward sub-network being arranged to classify a set of features that is produced, at least in part, by the at least one hidden layer, the set of features being produced based on the image.

42. The system of claim 39, wherein classifying the image with at least one neural network includes:
generating a one-dimensional signal based on the hyperspectral image and generating a first set of features based on the one-dimensional signal, the first set of features being generated by using a one-dimensional discrete Chebyshev transform;
generating a two-dimensional image based on the hyperspectral image and generating a second set of features based on the two-dimensional image, the second set of features being generated by using a two-dimensional or three-dimensional discrete Chebyshev transform;
generating a combined set of features based on the first set of features and the second set of features; and
classifying the combined set of features.
